(19) United States
(12) Patent Application Publication
(10) Pub. No.: US 2007/0121076 A1
(43) Pub. Date: May 31, 2007

(54) Arrangement for the three-dimensional display of a scene / an object

(76) Inventors: Markus Klippstein, Jena-Muenchenroda (DE); Dieter Storch, Jena (DE); Guenter Ross, Jena (DE); Uwe Jahrmarkt, Jena (DE); Hans-Juergen Rossbach, Hartmannsdorf (DE)

Correspondence Address: Douglas J Christensen;Patterson Thuente Skaar & Christensen, 4800 IDS Center, 80 South Eighth Street, Minneapolis, MN, 55402, US

(21) Appl. No.: 10/482,488

(22) PCT Filed: Sep. 2, 2003
(86) PCT No.: PCT/EP03/09723

§ 371 Date: Aug. 20, 2004

(30) Foreign Application Priority Data
Sep. 3, 2002 (DE) 202 13 819.4

(51) Int. Cl. G03B 21/26

(52) U.S. Cl. 353/30

(57) ABSTRACT

The invention relates to an arrangement for 3D image presentation, comprising a visual display device and an optical assembly (5) provided with a great number of optical elements, preferably filter elements, wherein, due to the positions of the optical elements, bits of partial information of a first selection of views of a scene/an object are visible to one eye, and bits of partial information of a second selection of these views are visible to the other eye of an observer.

The problem of the invention is solved by detachably connecting the visual display device and the optical assembly (5) by means of a fastening device. Fastening the optical assembly (5) to the visual display device converts the image display from monoscopic into autostereoscopic, and vice versa.

Preferably, the optical assembly (5) is provided with a structured plate (1), the structures of which form the plurality of optical elements, and the fastening device consists of means for influencing the air pressure between the structured plate (1) and the surface of a visual display device that is a flat-panel display, in which the generation of a vacuum between the structured plate (1) and the surface of the flat-panel display fixes the optical assembly (5) to the flat-panel display.

### FIELD OF THE INVENTION

The invention relates to an arrangement for the three-dimensional display of a scene/an object, in which a great number of pixels contain bits of partial information obtained from more than two views of the scene/object, comprising
a visual display device for the reproduction of the pixels, and
an optical assembly consisting of a great number of optical elements, preferably filter elements, and arranged before the visual display device with reference to an observer's viewing direction, wherein
   the positions of the optical elements within the optical assembly are defined in such a way that the light emerging from the pixels propagates in directions that intersect in observation positions from which bits of partial information of a first selection of views can be perceived by one eye, and bits of partial information of a second selection of views can be perceived by the other eye of an observer (or of several observers).

### DESCRIPTION OF PRIOR ART

In prior art, DE 100 37 437 A1 describes a structured plate suitable for monoscopic and autostereoscopic image display on flat-panel displays. Disclosed are technical features permitting the structured plate to be fitted to a flat-panel display reversibly. In special configurations, the structured plate is hung from a suitable mechanical connection attached to the top of the outer frame of the flat-panel display. The disadvantage of this solution is that the structured plate depends on the shape of the frame, i.e. the structured plate cannot be used with every flat-panel display.

WO 99/05559 discloses a method in which flat-panel display can be operated with a lenticular screen as an autostereoscopic display. While the disclosure describes embodiments in which the flat-panel display receives defined image information to achieve an autostereoscopic effect, no details are given about a practicable way of fastening the lenticular screen to particular flat-panel displays. The doctrine of this patent specification does not solve the problem of how an optical assembly configured as a lenticular screen can be mechanically attached to the flat-panel display, especially so as to be detachable again.

GB 472,562 A proposes a stereoscopic display device, in which an optical assembly configured as a barrier screen (“grating”) is integrated so as to be detachable, and describes auxiliary means to align the grating within the device to ensure stereoscopic presentation.

U.S. Pat. No. 5,500,765 A describes how the effect of a lenticular screen can be cancelled out by means of a complementary lenticular arrangement hinged down on it. This virtually turns off the 3D effect. This approach primarily works with lenticular systems only and requires the manufacture of an exactly complementary lenticular arrangement.

All patent specifications cited have in common that a practicable, reversible conversion of a flat-panel display to an autostereoscopic flat-panel display is hardly possible, if at all, especially if use is to be made not only of one particular make of flat-panel display but of any type of, say, 2D monitor configured as a flat-panel display. As proposed by EP 0860728 A1, a barrier screen is reversibly positioned in front of an monitor by means of a slide-in unit. In this way it is possible to switch from 2D to 3D, but the method is restricted to such display modules whose enclosures have a slide-in pocket for the barrier screen. This makes it inevitable to use specially designed screen enclosures. The said barrier screen cannot readily be attached to every flat-panel display. The other versions proposed, involving a hinging away or rolling up of the barrier screen also require the monitor to be provided with extra devices.

EP 0829744 A2 proposes a polarizing foil acting as a barrier screen, which is hooked to the top of the screen. Here again, the foil cannot be attached to every monitor with a few manipulations.

A detachable wavelength filter array is described in DE 200 13 873 U1. Here, the filter array is integrated in, e.g., a cartridge. For reversible conversion, the cartridge is simply put on the monitor like a cap; for 2D application, the cartridge is removed. However, given the diversity of monitor enclosures existing, it is not easy, to say the least, to manufacture one cartridge that would fit many different monitor makes and their different enclosure geometries. Also disclosed is a filter array that can be clipped onto the monitor from the front; this requires the monitor enclosure to be provided with an auxiliary device.

A switchable 2D/3D display is disclosed by JP 2002-084553 A. Switching between 2D and 3D requires a diffusing plate to be installed or removed. As a disadvantage, this requires the display, or its enclosure, to be of a particular design to permit 2D/3D switching.

EP 0535989 B1 describes an optical viewing device, e.g., an antiglare filter configured to permit its attachment to monitors of varied sizes by the user. A frame unit holds an optical screen, which also comprises a semi-flexible membrane. With the aid of the membrane, the device can be attached to a monitor. A practicable reversible conversion of a monitor into an autostereoscopic monitor is not possible with this device.

DE 4315146 A1 describes a display with an image screen and a transparent cover, wherein the cover can be attached to and removed from the image screen by means of a click-in mechanism, with lugs clicking into the front sides of the base plate. A practicable reversible conversion of a monitor of every make into an autostereoscopic monitor is not possible with this device.

### DESCRIPTION OF THE INVENTION

Proceeding from the prior art as described, it is the objective of the invention to create an arrangement of the kind described above under “Field of the Invention”, in which the optical assembly can be attached to, and easily removed again from, a visual display device irrespective, to the largest possible extent, of its configuration. The optical assembly is intended to be cost-effective, easy to implement and easy to handle. The invention further provides for a method permitting the cost-effective conversion between monoscopic and autostereoscopic renderings of the scene/the object.

According to claim 1 of the invention the problem is solved in that the visual display device and the optical assembly are detachably joined to one another by means of a fastening device, wherein fastening the optical assembly to the visual display device effects conversion from a monoscopic to an autostereoscopic image display, and removal of the optical assembly from the visual display device effects conversion from an autostereoscopic to a monoscopic image display.

In a first, preferred embodiment of the arrangement according to the invention, the optical assembly has a structured plate, the structures of which are formed by a great number of optical elements; the intended visual display device is a flat-panel display, and the fastening device consists of means for influencing the air pressure between the structured plate and the surface of the flat-panel display, so that the generation of a vacuum between the structured plate and the surface of the flat-panel display will make the optical assembly stick to the flat-panel display, and the generation of a normal or excess pressure between the structured plate and the surface of the flat-panel display will release the optical assembly from the flat-panel display.

It is of advantage if the structured plate is extensive in two dimensions. Moreover, it is favorable if the structured plate is held at its outer edges by a frame. This will inherently stabilize the structured plate. The frame may, e.g., consist of metal and may be relatively thin, i.e. several hundreds of micrometers.

It is of particular advantage if the frame is provided with one or several spacers for defined spacing of the structured plate from the surface of the flat-panel display. This spacing is sometimes needed for producing an autostereoscopic impression on the flat-panel display.

Moreover, the unit formed by the structured plate and the frame may be configured so that, when this unit is put on a flat-panel display, an essentially air-tight cavity is formed between the structured plate and the surface of the flat-panel display. This air-tight cavity enables the invention to be embodied especially in the way described, in that it permits easy generation of the desired vacuum between the structured plate and the surface of the monitor.

The means for influencing the air pressure between the structured plate and the surface of the flat-panel display preferably comprise at least one manually or electrically operated pump and/or one valve. In this way, the arrangement according to the invention can be implemented easily and cost-effectively.

Moreover, the means for influencing the air pressure may comprise a movable hem impermeable to air, that is fixed to the frame and designed in such a way that, when the optical assembly is pressed to a flat-panel display, a vacuum is formed between the structured plate and the surface of the flat-panel display, whereby the entire unit is held to the flat-panel display.

Moreover, the means for influencing the air pressure can comprise a valve that effects a pressure equalization between the location of the vacuum and the outer atmospheric pressure, so that the optical assembly can be easily removed. This embodiment of the invention can be manufactured easily and cost-effectively, too. The movable hem impermeable to air may be made, for example, of plastic or rubber.

It may possibly be of advantage if the optical assembly comprises, in addition, stripe-shaped segments consisting of rubber. These segments are intended especially for the air-tight sealing of joints within the optical assembly.

In addition or alternatively, a suction cup may be provided that is intended, by means of vacuum generation, for the reversible fastening of the structured plate to the flat-panel display, thus ensuring the reversible attachment of the optical assembly.

In a second preferred embodiment of the arrangement according to the invention, the visual display device again is a flat-panel display, whereas the means provided for fastening the optical assembly to the flat-panel display is an adhesive medium, preferably a liquid, which should absorb the least possible amount of light, and which consists, for example, of cedarwood oil.

This embodiment makes use of the adhesion between the atoms or molecules of the medium on the one hand, and the atoms or molecules of the surface of the flat-panel display or the structured optical plate on the other. The optical assembly can be detached by shifting, or—with a slight effort—by breaking the adhesive joint.

For all embodiments of the optical assembly described so far it may further be of advantage if these embodiments also comprise stripe-shaped segments consisting of some non-scratching textile material. Such non-scratching textile material segments help to avoid scratches on the flat-panel display.

Moreover, the optical assembly preferably has external dimensions allowing one or several of its outer edges, e.g., its frame, to rest on or against parts of the enclosure of the flat-panel display. Among other purposes, this allows a first, rough alignment of the structured plate relative to the structure of the imaging surface of the flat-panel display.

One prerequisite for obtaining a 3D impression is the presentation of suitable images on the flat-panel display. Such images may be image combinations of several views of a scene, for example, perspective views. The term “image combination” or “combination image” refers to an image compiled from the image information contained in several views and arranged in rows and/or columns.

Further explanations of how an image combination is compiled are found, e.g., in DE 100 03 326 C2. This patent specification further contains example embodiments of wavelength filter arrays suitable for autostereoscopic display. It may be noted here that, if a wavelength filter array is used, partial images need not be completely separated to create an autostereoscopic display; i.e. either eye of the observer only predominantly sees a selection of various views. They may even simultaneously see a certain percentage of image information assignable to one and the same view. Hundred-percent optical separation of partial images is not always necessary.

If the optical assembly is removed from the flat-panel display, the latter returns to the usual monoscopic, i.e. two-dimensional display with full, unaffected resolution, showing either a plain 2D image of an object or, for example, a text.

For special applications it may be an advantage also if the structured plate consists of more than one layer. For example, the structured plate may consist of a substrate with a wavelength filter array laminated or printed on it. This is a way to implement the invention easily and cost-effectively. Preferably, the substrate is as stable, thin and fully transparent as possible; it may, for example, be a glass pane. The wavelength filter array should preferably be on the substrate side facing the monitor, i.e. the flat-panel display.

Furthermore, it is favorable to provide means to make the structured plate movable. This is of advantage especially if, for example, the structured plate is to be used in combination with a tracking unit for detecting the eye position(s) of one or several observers. The structured plate can then be controlled—e.g., via a PC analyzing the observer's eye positions detected—so that an optimum effect of the structured plate is achieved with relation to the observer, who then is continuously given a 3D impression. Such tracking devices are well known in conjunction with 3D presentation and need not be explained in detail here.

Depending on the embodiment of the invention it is of advantage if the frame and/or the means for influencing the air pressure and/or the suction cup are designed to be outside the image field of the flat-panel display as far as possible. This can be achieved, e.g., by the suction cup having very small dimension and the frame being very narrow (as mentioned before). Also, the means for influencing the air pressure can be provided at the edge of the structured optical plate or, at least in part, incorporated into the frame (if provided) of the optical assembly.

The invention can be used, for example, for flat-panel displays of the LCD type or for plasma displays. It can just as well be used with any other kind of image display system. In particular, it can be used with a CRT monitor, provided the geometry of the optical assembly is adapted to the CRT shape.

Further advantages result if the structured plate, for example, covers only part of the flat-panel display and/or is moved only partially into or out of the observation beam path. Further, the optical assembly can be provided with a handle frame at its top end, which allows temporary holding the optical assembly during its removal from the flat-panel display. For this purpose, the handle frame would, e.g., be temporarily hooked to the upper edge of the enclosure of the flat-panel display. Optionally it can be designed to be removable from the optical assembly.

In a third preferred embodiment of the arrangement according to the invention, the optical assembly has a structured plate with a large surface each in front and at the rear, and narrow surfaces all along its edges, and it is provided with at least one fastening element, which is either rigid or movable and from at least one of the narrow side faces, fastening of the optical assembly being achieved by pushing the fastening element between two components of the flat-panel display, preferably between a segment of the display module and a segment of its enclosure.

This allows the optical assembly to be attached to and removed from the flat-panel display largely irrespective of the latter's enclosure geometry, because flat-panel displays tend to be provided with narrow grooves between the display module and its enclosure, into which the fastening element, designed, e.g., as a fastening lug, can be inserted.

Such an optical assembly can be manufactured easily and cost-efficiently. This optical assembly is particularly user-friendly in that it can very easily be attached to and removed from a flat-panel display without requiring much know-how of the user.

As long as the optical assembly according to the invention is attached to it, a flat-panel display is used as a 3D screen, provided that the image contents to be displayed are suitable for such use. For common, unaffected 2D presentation, the optical assembly can be removed from the flat-panel display.

Within the scope of this invention, the term “display module” primarily refers to a flat-panel display (e.g., TFT-LCD or plasma display), which comprises the image rendering surface. This does not exclude that electronic or other components may be provided behind the image-rendering surface that are quasi-inseparable parts of the display module.

To ensure that the structured plate is as versatile in use as possible, it is, also in this case, preferably designed to be positioned within extensions of the enclosure of the flat-panel display which extend past the display module of the flat-panel display toward the observer.

So, if a flat-panel display of a particular make is intended to be used, or if, at least, the visible surface of such a flat-panel display to which an optical assembly according to the invention is to be attached has been specified, the dimensions of the large front and rear surfaces of the structured plate should essentially correspond to those of the visible image area of the display module of the flat-panel display used. If, for example, an optical assembly for 15.1″ TFT-LCD screens has an aspect ratio of 4:3, the structured plate, or strictly speaking, its large front and rear surfaces should have dimensions of 307.2 mm×230.4 mm.

Here again, a good mechanical stability is achieved if the optical assembly has external dimensions allowing one or several of its outer edges to rest on or against parts of the enclosure of the flat-panel display, especially on the said enclosure extensions. Suitable for this is, in particular, the enclosure extension below the image area of the flat-panel display; but the optical assembly may just as well rest on the inside edge of a right and/or left and/or upper enclosure extension.

Further, it is favorable if the optical assembly has two or more fastening lugs, which jut out from at least two of the narrow edge faces of the structured plate.

In a particularly advantageous embodiment, at least two fastening lugs are provided, with at least one of the fastening lugs being movably joined to the structured plate via a mechanical sliding and/or swiveling device, so that, when the optical assembly is being attached to a flat-panel display, the fastening lug can be brought into a position relative to the structured plate in which it does not substantially jut out from a narrow edge face, and that, for the reversible attachment of the optical assembly to the flat-panel display, the fastening lug can be brought into a position relative to the structured optical plate in which it juts out from a narrow edge face and is, at the same time, located between two components of the flat-panel display.

Such a sliding device may comprise at least one slide rail and/or one pin. Such a swiveling device preferably comprises at least one hinge and/or one pin. Thus, these movable fastening lugs can be implemented with relatively simple and cost-efficient means, too.

This configuration facilitates the attaching operation for the user, since there is no need during attachment for all fastening lugs provided to jut out from the respective narrow edge faces.

For easier manipulation, at least one of the fastening lugs that are movably joined to the structured plate may have a handle that permits manual handling of the fastening lug. Preferably, each of the fastening lugs is provided with such a handle.

The optical assembly can be manipulated with still greater ease if the mechanical sliding and/or swiveling device for at least one of the fastening lugs includes a restoring element, e.g., a spring. This restoring element puts the fastening lug into a certain position relative to the structured plate, preferably into such a position in which the fastening lug juts out from one of the narrow edge faces of the structured plate. In this case the user, when attaching the optical assembly to the flat-panel display, merely needs to pull the fastening lug back against the spring force. Once the optical assembly has been put against the flat-panel display, it is sufficient to release the respective handle to achieve fastening of the optical assembly to the flat-panel display.

It is of advantage if the optical assembly is configured with the large surfaces of the structured plate having rectangular dimensions and with two fastening lugs each provided on the left-hand and right-hand narrow sides of the structured plate, with the two fastening lugs on one narrow side being rigidly joined to the structured plate and the two fastening lugs on the other narrow side being movably joined to the structured plate.

Further, the optical assembly may be provided with at least one clamp, preferably on a narrow edge face of the structured plate. This clamp is intended to establish a clamping joint between the narrow edge face of the structured plate and an enclosure part of a flat-panel display. Such clamps can be used to advantage if no movable fastening lugs are provided.

In the embodiments of the optical assembly described so far, at least one of the fastening lugs has a length that is between 0.2% and 100% of the length of that narrow edge face of the structured optical plate from which the fastening lug juts out.

For cost-effectiveness, each fastening lug can be designed as a small, narrow plate, especially made of metal (e.g., of thin special steel). With the optical assembly attached to a flat-panel display, the fastening lugs should not, if possible, jut out into the visible part of the image area of the display module of the flat-panel display so that no pixels are hidden from view. Preferably the fastening lugs should be provided below non-transparent components of the structured plate, such as opaque filters of a wavelength or neutral-density step filter array, so as not to affect image display.

If a fastening lug is directly and rigidly joined to the structured plate, it may be provided with a connecting piece preferably made of metal or plastic and firmly clamped or riveted to the structured plate or joined to it in any other way.

In this connection, each fastening lug is preferably designed so that it holds a structured plate attached to the flat-panel display at a defined distance, preferably of 1 to 8 mm, from the display module of the flat-panel display. This can easily be achieved if the said connecting piece is of an appropriate length.

Further, it may possibly be favorable if the optical assembly is provided with a frame that wholly or partially frames the structured plate at least at their narrow edge faces, and via which the fastening lugs are rigidly or movably joined to the structured plate, with the fastening lugs consequently protruding outwardly especially from the frame. In this connection it should be noted that the wording “extension of a fastening lug from a narrow side” is inclusive; this means that the respective fastening lug juts out not only from a narrow side, but also, in particular, (outwardly) from the respective frame part.

One advantage of such a frame is that it improves the firmness of attachment of the optical assembly, since potential mechanical loads, such as external forces, will not essentially act on the structured plate alone but also on the frame. Such a frame would be made of metal—especially of stainless steel or aluminum—or of plastic. Another advantage of the frame is that it can simultaneously be used for spacing the structured optical plate from the flat-panel display. For that purpose it has an appropriate depth, providing for the desired spacing of the fastening lugs from the large rear surface (in viewing direction) of the structured optical plate.

To avoid scratches on the flat-panel display, the optical assembly further comprises stripe-shaped segments consisting of some non-scratching textile material or rubber, which are preferably fitted to the fastening lugs.

Each of the embodiments of the optical assembly described so far is preferably provided with a structured plate that at least comprises a wavelength filter array, a neutral-density step filter array, a lenticular screen, a barrier screen, a polarizing filter array, a lenslet array or a prism array. This does not exclude the possibility that several of the said arrays may be provided on a structured plate in various combinations.

Further configurations in that context are feasible, especially such including obliquely positioned lenticular or barrier screens.

Preferably, the structured plate comprises at least one filter array consisting of a plurality of wavelength filters, neutral-density step filters and/or polarizing filters. In this way, the optical assembly mounted to a flat-panel display, thanks to the effect of its structured plate, provides defined propagation directions for the light emitted by the individual pixels of the display module of the flat-panel display, so that any one pixel of the display module corresponds with several correlated wavelength, neutral-density or polarizing filters of the filter array, or on wavelength, neutral-density or polarizing filter of the filter array corresponds with several correlated pixels of the display module, in such a way that straight line between the centroid of the cross-section area of a visible segment of the pixel and the centroid of the cross-section area of a visible segment of the wavelength, neutral-density or polarizing filter corresponds to one propagation direction. For that reason, and provided that the display module renders an image combined of at least two views of a scene/an object, an observer will see, from any observation position, predominantly bits of partial information of a first selection from the views with one eye, and predominantly bits of partial information of a second selection from the views with the other eye, so that, from a plurality of observation positions, the observer is given a 3D impression. Suitable filter arrays are known to the specialist; detailed explanations can be found in WO 01/56265 A and DE 201 21 318 U1, among other sources.

Sometimes it may be desirable to convert only part of the image area of the display module for 3D display. For this case, the structured plate of the optical assembly is designed so that only part of its surface is provided with optical components for image splitting—for example, wavelength filters—whereas the remainder of the surface is largely optically inactive or transparent.

To permit the optical assembly to be adjusted after it has been attached to the flat-panel display, another advantageous embodiment comprises additional means for adjusting the position of the optical assembly relative to the flat-panel display. These means especially consist in a micrometer and/or an eccentric mechanism. The micrometer or the eccentric disc exert, in a defined manner, a force on one component of the flat-panel display, preferably on the display module and/or a segment of the enclosure, so that the relative position of the optical assembly is influenced via the force setting. Adjustment like this may be necessary, when lenticular screens are used, to align the lenticular images with the positions of the pixels to achieve an optimum autostereoscopic display.

Further, the optical assembly can be provided with at least one carrying handle, which may be detachable. The carrying handle permits convenient carrying of the optical assembly when this is not attached to the flat-panel display.

Preferably, the structured plate is of a multilayered design. Eligible layers, in particular, are transparent substrates such as glass or PMMA, on which further, preferably optically effective layers are applied. Such layers may be, e.g., a lenticular screen made of PMMA, or adhesive films, each of which to join the two layers above and below it.

Preferably, the structured plate consists of a substrate with a wavelength or neutral-density step filter array laminated or printed on it. The filter array is arranged on the rear side of the substrate, seen in the viewing direction. The substrate preferably is a glass pane. If to be laminated onto the substrate, the filter array can be previously fabricated by exposure of a photographic plate or film. Methods for printing filter arrays onto (glass) substrates are known in prior art and need not be explained any further here. Alternatively, the filter arrays can be applied to a substrate by vapor deposition or lithography. It is important to ensure that all substrates have the highest possible transparency for optimum light yield.

For special embodiments of the invention, means for the movable positioning of the structured plate at the flat-panel display. For example, roller bearings or rails are suitable means to achieve this. Such embodiments may be of interest where autostereoscopic eye position tracking methods are used, such as where the image splitting optics (in this case, the structured plate, is required to track the changing eye position of the observer.

For easy handling of the optical assembly, its upper end may be provided with a handle frame, which allows the optical assembly to be held during its removal from the flat-panel display; optionally, this handle frame may be detachable. The handle frame may, for example, be attached to the optical assembly just before this is removed from the flat-panel display, and temporarily be hooked or clamped around the upper end of the flat-panel display enclosure. When the fastening lugs are then pulled out of the slots provided between two components of the flat-panel display, the optical assembly is temporarily held by the handle frame. For final removal from the flat-panel display, the handle frame is detached together with the optical assembly. The handle frame is then detached from the assembly so that the latter can more easily be stowed away, e.g., in a protective pouch made of a velvet-like fabric.

In a fourth preferred embodiment of the arrangement according to the invention, the visual display device is a flat-panel display that comprises at least a display module and an enclosure, and the fastening device for the optical assembly, which also comprises a structured plate, consists in magnetic means.

In this way, at least one ferro- or paramagnetic component can be rigidly or movably fastened to the structured plate, and at least one strip-shaped permanent magnet can be provided, which has an adhesive face by which it is adhesively joined to the enclosure of a flat-panel display, so that the optical assembly can be detachably fastened to the flat-panel display by attaching the ferro- or paramagnetic component of the structured plate to the strip-shaped permanent magnet.

The ferro- or paramagnetic component can preferably be incorporated into, or configured as, the frame of the optical assembly, with the frame framing the structured plate. Such a frame moreover increases the stability of the optical assembly. It is, of course, also possible that the display module and the enclosure of the flat-panel display used are designed as one unit.

Alternatively, at least one permanent magnet may be rigidly or movably fastened to the structured plate, and at least one strip-shaped component may be provided, which has ferro- or paramagnetic properties and is glued to the enclosure of the flat-panel display, so that the optical assembly can be detachably fastened to the flat-panel display by attaching the permanent magnet of the structured plate to the strip-shaped ferro- or paramagnetic component.

Furthermore, a first permanent magnet can be rigidly or movably fastened to the structured plate, and at least a second strip-shaped permanent magnet can be provided which is designed to attract the first permanent magnet, and which has an adhesive face by which it is firmly joined to the enclosure of a flat-panel display, so that the optical assembly can be detachably fastened to the flat-panel display by attaching the first permanent magnet to the second permanent magnet.

In these configurations as well, the ferro- or paramagnetic component can preferably be incorporated into, or configured as, the frame of the optical assembly, with the frame framing the structured plate.

If, during its manufacture, a flat-panel display is prepared for its later temporary conversion into an autostereoscopic display, the ferro- or paramagnetic component, or a strip-shaped magnet, if any, can be incorporated into the enclosure of the flat-panel display. The component incorporated into the enclosure would not be visible externally then, but still be of sufficient magnetic effect. If the enclosure of a flat-panel display should itself have ferro- or paramagnetic properties, the ferro- or paramagnetic component provided as part of the optical assembly will not be needed. The optical assembly would then essentially consist of at least one structured plate and at least one strip-shaped permanent magnet.

Preferably, the optical assembly is designed so that the dimensions of the large surfaces of the structured plate are larger than or equal to the visible surface of the display module of the flat-panel display used. This is not absolutely necessary, however. If, for example, only part of the display module is to be designed for three-dimensional viewing, the structured plate may be smaller. In this case it is also possible, however, to limit the optically effective portions of the structured plate to the size of the desired image field.

Positioning an optical assembly is facilitated for the user also if, for example, its outer dimensions are so designed that, when it is attached to the flat-panel display, one or several of its outer edges are in contact with segments of the enclosure of the flat-panel display, especially with enclosure extensions. The user can, in this case, attach the optical assembly to the enclosure guided by one or several of such enclosure extensions serving for location.

Further, the strip-shaped permanent magnet or the ferro- or paramagnetic component can be provided with locating angle plates, against which one outer edge of the structured plate can be located for easier alignment. It is especially favorable to have two or three locating angle plates on different sides of the flat-panel display enclosure, as this will establish a defined position of the optical assembly. This way, software calibration for the actual position of the optical assembly need be carried out only once, as thanks to the locating angle plates, the optical assembly will always be attached in exactly the same position.

The combination structure of an image combined from several views and to be displayed by the flat-panel display module has to be aligned with the actual position of the optical assembly or, especially, with the structured plate contained in it; for this alignment, software is required as a rule. In a special embodiment version, the structured plate has at least one layer that is—preferably at the margin only—vapor-coated with some ferro- or paramagnetic material.

Further, the problem of the invention is solved by a separate frame that is shaped to temporarily receive the optical assembly and has an adhesive face by which it is permanently joined to the enclosure of a flat-panel display, so that the optical assembly can be detachably fastened to the flat-panel display by inserting it into the separate frame glued to the enclosure of the flat-panel display.

Further, the problem of the invention is solved by at least one flexible clip, with which the structured plate can be fastened to the flat-panel display, in that the clip presses on the structured plate while simultaneously reaching around at least part of the enclosure of the flat-panel display and exerting a permanent force on another part of the enclosure, thus holding the structured plate to the flat-panel display.

Finally, the problem of the invention is solved by an arrangement of the type described at the beginning, in which the display module has a tilt angle of greater than zero relative to the vertical and the enclosure has an extension, say, below the bottom edge of the screen surface of the display module and facing the observer, comprising at least:
one structured plate that is extensive in two dimensions, which ensures image sorting for autostereoscopic presentation on flat-panel displays, and
at least one spacer rigidly fastened, say, at the bottom edge of the rear side of the structured plate, with the aid of which spacer the optical assembly is placed onto an enclosure extension so that
the structured plate is held to the flat-panel display due to gravity and because of the existing tilt of the display module relative to the vertical, with the top edge of the structured plate preferably resting against the outside of the top part of the enclosure of the flat-panel display or spaced from the monitor surface by means of another spacer.

Display modules tilted in that way are common, for example, in portable computers such as notebooks or laptops. With such devices, therefore, this embodiment version of the invention can be used to particular advantage. If the portable device includes, e.g., a touch-sensitive screen located at a distance of several millimeters from the monitor surface of the display module, the spacers just mentioned may be dropped completely. In this case it is sufficient for the optical assembly consists of the structured plate only and if this is fitted between existing enclosure extensions.

The structured plate can then be easily removed for 2D application. The version mentioned last is of advantage especially with PDAs and similar devices. As a rule, though, this requires that the screen surface is tilted relative to the vertical to prevent the structured plate from falling out, unless the structured plate is pressed in between existing enclosure extensions with a mechanical stress.

In general, the structured plate should have an essentially rectangular outline. However, other shapes are feasible as well, such as, for example, rounded off or polygonal shapes. Such a structured plate may have one or several recesses around its periphery that facilitate its removal from the enclosure or the enclosure extensions. For example, the corners of a structured plate of rectangular shape may be rounded off or beveled.

The invention further relates to a method for the temporary conversion of a flat-panel display into an autostereoscopic flat-panel display, using an optical assembly as described before. The method according to the invention comprises the following steps:
Manufacturing or provision of an optical assembly that satisfies at least one of the claims herein,
Manufacturing or provision of a flat-panel display with at least a display module and an enclosure, the projecting part of which forms a recess in front of the display module of the flat-panel display that is sufficiently large to receive a part or most of the structured plate of the optical assembly,
Reversible fastening of the optical assembly to the flat-panel display by pushing at least one of the fastening lugs provided on the optical assembly between two components of the flat-panel display, preferably between a segment of the display module and a segment of the enclosure.

Suitably adapted, these steps of the method can also be applied to the other embodiments of the invention.

The order of the first two steps may of course be reversed, as, for example, when a flat-panel display is provided first and the optical assembly after. In principle, the method is executed whenever a user attaches an optical assembly to a flat-panel display reversibly, i.e. detachably, and temporarily.

To convert a flat-panel display into an autostereoscopic screen conveniently and at affordable cost, the invention contemplates another method that comprises the following steps:
Manufacturing or provision of an optical assembly satisfying at least one of the claims herein,
Manufacturing or provision of a flat-panel display with at least a display module and an enclosure, the projecting part of which forms an indentation in front of the display module of the flat-panel display that is sufficiently large to receive a part or most of the structured plate of the optical assembly,
Permanent fastening of the optical assembly to the flat-panel display by pushing at least one of the fastening lugs provided on the optical assembly between two components of the flat-panel display, preferably between a segment of the display module and a segment of the enclosure.

With the permanent fastening of the optical assembly to the flat-panel display, this is converted virtually irreversibly into an autostereoscopic flat-panel display. Preferably, the step of permanently fastening the optical assembly to the flat-panel display is supplemented by one of the following actions, which replace the last-named of the above steps:
Provision of an adhesive joint between at least one of the narrow edge faces of the structured plate of the optical assembly and a component of the flat-panel display, using, for example, some double-face adhesive tape or some adhesive agent, and/or
Provision of an adhesive joint between the large rear surface (in viewing direction) or—if provided—the frame of the structured plate and a component of the flat-panel display, using, for example, some double-face adhesive tape or some adhesive agent, with the double-face adhesive tape or adhesive agent being applied to the large rear surface (in viewing direction) or the frame of the structured plate before attaching the optical assembly to the flat-panel display, and allowing for a time for the adhesive agent or the double-face adhesive tape to dry after attachment of the optical assembly to the flat-panel display, and/or
Provision of an adhesive joint by applying some fluid as, e.g., cedarwood oil, between the structured plate or its frame and a component of the flat-panel display, and/or
Provision of a firm joint between the structured plate and the flat-panel display by soldering or welding.

The invention further relates to a method of temporary conversion of a flat-panel display into an autostereoscopic flat-panel display, using an optical assembly according to one of the embodiment versions described before, comprising the following steps:
Manufacturing or provision of an optical assembly according to one of the embodiments described before,
Manufacturing or provision of a flat-panel display with at least a display module and an enclosure,
Adhesive joining of at least one strip-shaped permanent magnet or at least one strip-shaped ferro- or paramagnetic component of the optical assembly to the enclosure of the flat-panel display,
Reversible fastening of the optical assembly to the flat-panel display by attaching the ferro- or paramagnetic parts to the respective permanently magnetic parts.

The step described last of course also includes the case in which at least one first and at least one second permanent magnet belong to the optical assembly. Adhesive joining of the strip-shaped permanent magnet or the strip-shaped ferro- or paramagnetic component to the flat-panel display is done preferably to the front side of the screen enclosure.

The method steps described so far can be supplemented by the following step:
Adjustment of the position of the structured plate of the optical assembly relative to the display module of the flat-panel display.

This adjustment especially serves the purpose of influencing the interaction between the structured optical plate and the pixels of the display module of the flat-panel display in such a way that the image sorting geometry for the purpose of autostereoscopic presentation is optimized. If the structured optical plate contains, e.g., a lenticular screen, this would be aligned so that the principal direction of its cylinder vertices forms a defined angle with, or is parallel to, the orientation of the said pixels.

Preferably, this adjustment is carried out as follows:
Presentation of a test image on the display module, the test image preferably being an image arranged in rows and/or columns combined from n (n>2) views, with exactly (n−1) of the views each corresponding to one completely black area each, and exactly one view corresponding to a completely white or completely blue or completely green or completely red area,
Continuous shifting of the position of the structured plate of the optical assembly relative to the display module of the flat-panel display, and simultaneous visual inspection of the monocular images visible from an arbitrarily chosen but permanent monocular observation position until the shifting has moved the structured plate to such a position relative to the display module in which the monocular image shows a white, blue, green or red area of maximum extension.

Such a white or colored area of maximum extension may, but need not, be visible all over the visible monocular image segment. Also feasible are one or several polygons, or partial areas with rounded outlines, that in toto make up areas of maximum extension. By the way, for monocular vision, the observer merely needs to close one eye.

Of course, the image combination structure on which the combination of the n (test) views is based should correspond to the structured plate used. If the structured plate contains a wavelength filter array, the example filter arrays described in utility patent specification DE 201 21 318 U1 would preferably be adjusted using the respective example image combinations described there as test view combinations.

The method steps described so far may be followed by another step:
Presentation of an image combined from several views of a scene and/or object on the display module to obtain an autostereoscopic presentation.
   Specialists know how an image combined from several views can be obtained; reference is made again to WO 01/56265 A.

When an image combined from several views of a scene and/or object is presented on the display module, the image combination may possibly be effected in such a way that to at least one physically smallest pixel of the display module, preferably a color subpixel, there is correlated image information from pixels of two different views at a time. This will densify the image information and/or adapt the spatial representation to a desired observation distance, allowing for the distance of the display module surface from that layer of the structured optical plate which splits the partial views (see also DE 101 45 133 C1), or it will likewise adapt the image contents shown to a potential rotation of the structured optical plate or of the optical assembly relative to the display module of the flat-panel display.

Thus, when an image combined from several views of a scene and/or object is presented, the image combination is effected preferably by compensating to the greatest possible extent any rotation of a preferred direction of the pixels of the monitor, e.g., the columns of the pixels, relative to a quasi-parallel preferred direction of an array on the structured optical plate, e.g., the columns of the filter elements; such compensation to be effected by varying the horizontal and/or vertical grid spacing of the views in the respective image combination structure intended for the image that is presented by the pixels of the monitor, in such a way that a preferred direction defined by a sequence of next-neighbor positions of bits of image information from one and the same view on the varied image combination structure is approximately parallel to a preferred direction defined by a sequence of non-opaque next-neighbor filter elements on the wavelength or neutral-density step filter array. This applies to all embodiments of the invention.

Further, when an image combined from several views of a scene and/or object is presented on the display module, image combination may be effected in such a way that any undesirable rotation (i.e. non-parallelism) of a preferred direction of the pixels, e.g., the pixels arranged in columns, relative to a quasi-parallel preferred direction of an array on the structured plate, e.g., the filter elements arranged in columns, is compensated to the greatest possible extent by a corresponding complementary rotation of the image presented by the pixels.

The term “quasi-parallel” preferred directions essentially refers to the directions intersecting at an angle of maximally about 5°. The complementary rotation of the image presented may be effected using the approach described above, which simultaneously correlates image information from pixels of two different views to at least one physically smallest pixel of the display module.

As a rule, this makes it necessary that—as mentioned before—image information of two different views are simultaneously correlated to at least one pixel, in order to achieve the correspondingly varied image combination structures with suitably varied horizontal and/or vertical periods of the views.

The invention can also be used on monitors other than of the flat-panel displays type. In this case, the structured optical plate may have to be provided with a curvature to ensure sufficient splitting of partial images for a stereoscopic presentation.

### BRIEF DESCRIPTION OF THE DRAWINGS

Below, the invention is described in detail with examples of embodiments. Reference is made to the accompanying drawings, in which:

FIG. 1 shows a fist embodiment version of the optical assembly,

FIG. 2 shows a second embodiment version of the optical assembly,

FIG. 3 shows the principle of an optical assembly,

FIG. 4 shows the principle of attaching the optical assembly to a flat-panel display,

FIG. 5 shows a detail of an optical assembly, in which a frame is provided that doubles as a spacer,

FIG. 6 shows a detail of an optical assembly, in which a frame and at least one movable fastening lug is provided,

FIG. 7 shows a detail of an image combination composed of eight views that is suitable for 3D presentation,

FIG. 8 shows an example of the structure of a wavelength filter array that together with the image combination shown in FIG. 7 is suitable for 3D presentation,

FIGS. 9 and 10 show examples of possible view mixes visible to the right and the left observer eye, respectively, based on a wavelength filter array according to FIG. 8 and an image combination structure according to FIG. 7,

FIG. 11 shows a detail of an image combination composed of four views, that is suitable for 3D representation,

FIG. 12 shows an example of the structure of a wavelength filter array that, together with the image combination shown in FIG. 11, is suitable for 3D representation,

FIGS. 13 and 14 show examples of possible view mixes visible to the right and the left observer eye, respectively, based on a wavelength filter array according to FIG. 12 and an image combination structure according to FIG. 11,

FIG. 15 is a schematic representation of the case the structured plate is attached in a position that is rotated relative to flat-panel display,

FIG. 16 is a detail sketch showing the principle of how the rotation shown in FIG. 15 can be corrected by means of a modified image content,

FIG. 17 is a detail sketch showing the principle of a possible view mix visible to one observer eye in case a wavelength filter array is attached in a position that is rotated relative to the flat-panel display,

FIG. 18 is a detail sketch showing the principle of how the rotation shown in FIG. 17 can be corrected by means of a modified image combination structure,

FIG. 19 is a detail sketch showing the principle of a preferred direction defined by a sequence of next-neighbor positions of bits of image information from one and the same view on an image combination structure,

FIG. 20 is a detail sketch showing the principle of a preferred direction defined by a sequence of non-opaque next-neighbor filter elements on a wavelength filter array attached in a position that is rotated relative to a flat-screen display, and

FIG. 21 is a detail sketch showing the principle of a preferred direction defined by a sequence of nearest-neighbor positions of bits of image information from one and the same view on a varied image combination structure.

### DETAILED DESCRIPTION OF THE DRAWINGS

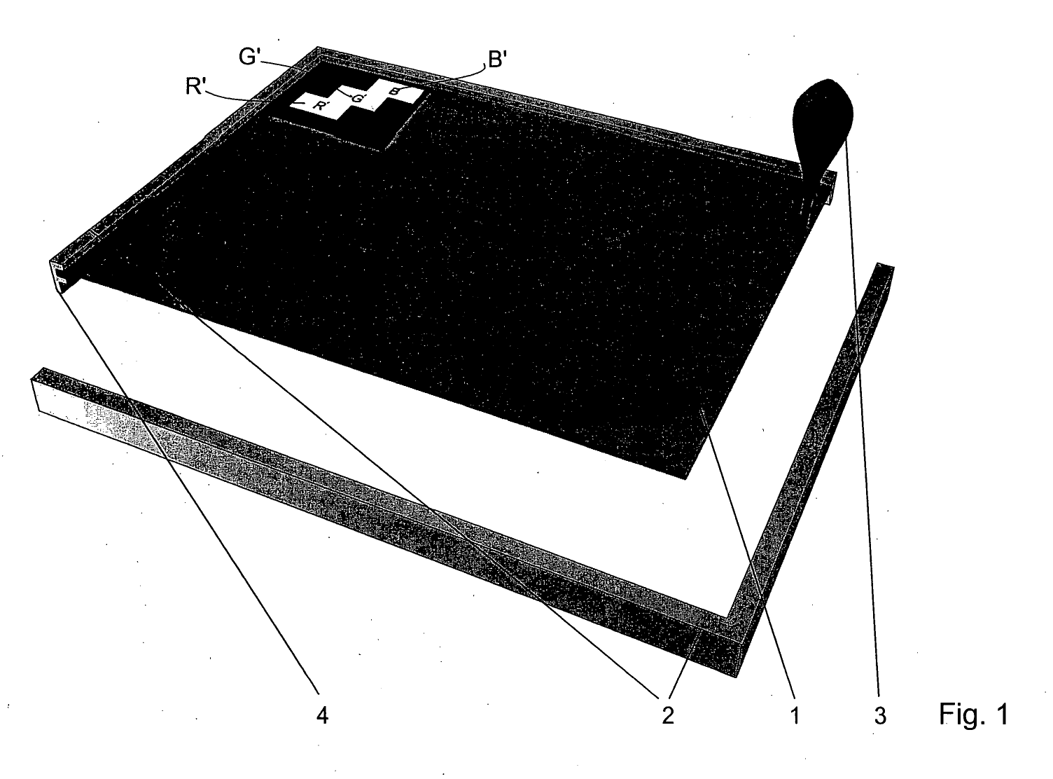

FIG. 1 shows a first example of an embodiment of an optical assembly, wherein the optical assembly consists of an structured optical plate 1, a frame 2 to receive the structured plate 1, and means 3 to influence the air pressure between the structured plate 1 and the surface of a flat-panel display.

The flat-panel display is not shown in the drawing; it would be located below the optical assembly according to the invention. In practical applications, of course, the surface of the flat-panel display would be arranged vertically, and the optical assembly according to the invention would be attached to this in an appropriate position.

The means 3 for influencing the air pressure are shown, by way of example, as a blowbulb with which the air pressure between the structured plate 1 and the surface of the flat-panel display can be influenced. It provides an easy way to implement the idea of the invention: If a vacuum is generated between the structured plate 1 and the surface of the flat-panel display, e.g., by compressing the blowbulb, the optical assembly gets attached to the flat-panel display. There is an air-permeable connection—not shown in the drawing—between the blowbulb and the space between the structured plate 1 and the surface of the flat-panel display.

The generation of a normal or excess pressure between the structured plate 1 and the surface of the flat-panel display permits the optical assembly to be detached from the flat-panel display. Here, the structured plate 1 consists, for example, of a transparent glass substrate and a wavelength filter array on the side facing the flat-panel display.

The wavelength filter array is indicated in FIG. 1 by the detail R′, G′, B′, which shows only a few wavelength filters of the structured plate 1. Actually, however, the filter array comprises a large number of individual wavelength filters in defined positions, as described, e.g., in DE 100 03 326 C2. The wavelength filter array can be implemented as an exposed sheet of film laminated to the rear side of the glass substrate (in viewing direction).

The frame 2 as shown in FIG. 1 is exaggerated in size so that its function is understood better. Actually it is of a slender design to cover as few pixels flat-panel display as possible. The frame 2 mounts the structured plate 1 on all sides, as shown in FIG. 1. The frame 2 is provided with a spacer 4 on all sides, which provides for a defined spacing of the wavelength filter array from the flat-panel display.

Here, the frame 2 is shown separated from the spacer 4 for clarity. In the practical embodiment, however, both components are in direct contact with the structured plate 1, so that this is completely mounted on all sides.

If the optical assembly is attached to a flat-panel display and if the flat-panel display shows a suitable image carrying 3D information, the observer sees a three-dimensional image without the need to wear 3D goggles. After the optical assembly has been removed, the flat-panel display can be used for two-dimensional display with undiminished resolution.

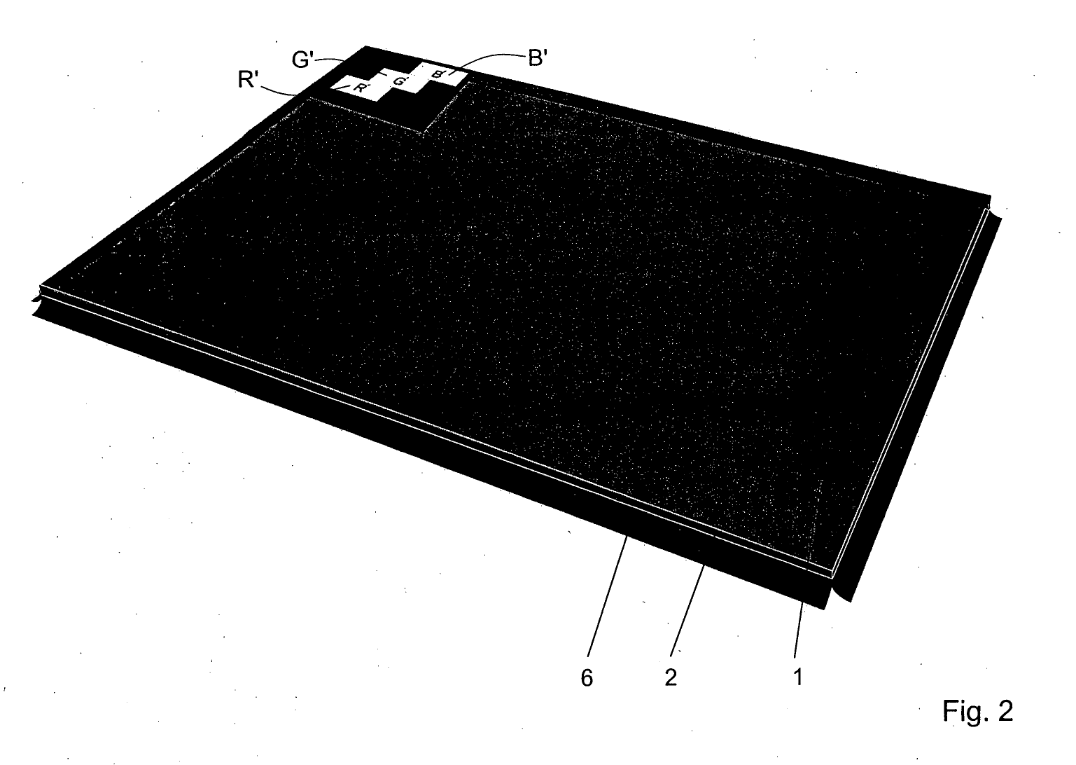

FIG. 2 shows another example of an embodiment of the invention. Here again, an structured optical plate 1 consisting of a glass substrate with laminated filter array, and a frame 2, which mounts the structured plate 1. In addition, a hem 6 is provided that is made, for example, of rubber or plastic and holds the entire optical assembly in place when it is pressed to the image surface of a flat-panel display.

Here, the entire optical assembly acts similar to a suction pad. For detaching the optical assembly, further means may be provided, as, e.g., a valve (not shown in the drawing), which effects a pressure equalization between the atmospheric pressure and the space between the structured plate 1 and the surface of the flat-panel display if required. After pressure equalization, the entire optical assembly can easily be removed from the flat-panel display again.

For clarity, the corners of the hem are not shown in FIG. 2. However, these do exist in the real embodiment, ensuring that the hem is air-tight all around. Moreover, this embodiment may also be provided with a spacer (not shown in the drawing).

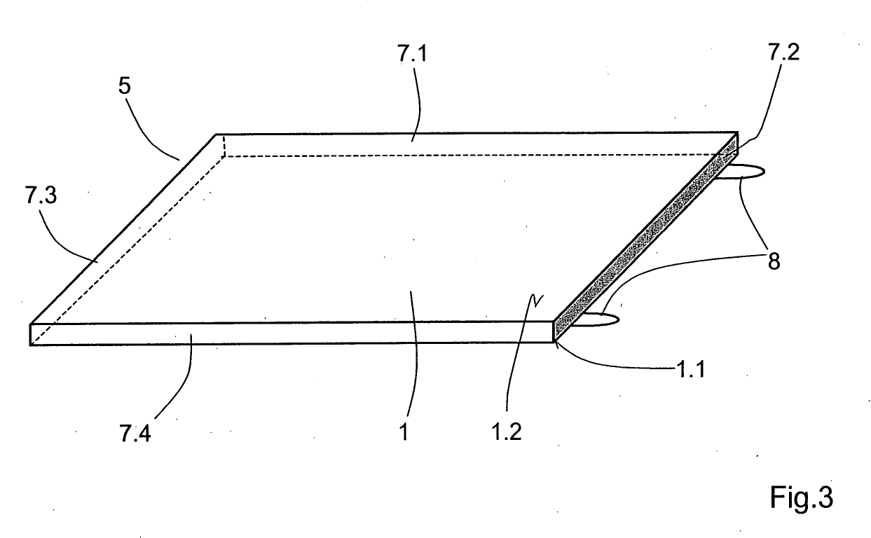

FIG. 3 shows the principle of an optical assembly 5. The optical assembly 5 is designed to be fastened to a flat-panel display provided with at least a display module and an enclosure and to separate the partial images of the flat-panel display for autostereoscopic presentation. The optical assembly 5 as shown in the drawing comprises at least the following components:
a structured plate 1 that has a front 1.2 and a rear large surface 1.1 and 7.1, 7.2., 7.3 and 7.4 on all four sides and that ensures the separation of partial images for autostereoscopic presentation on flat-panel displays, and
at least one fastening lug 8 that is rigidly or movably connected with the structured optical plate 1 and juts out on at least one of the narrow edge faces of the structured plate 1 (in the drawing: narrow edge face 7.2), wherein the fastening lug 8 is intended for fastening the optical assembly 5 detachably to the flat-panel display in that it is pushed in between two components of the flat-panel display, preferably between a segment of the display module and a segment of the enclosure.

This ensures that the optical assembly 5 can be attached to, and optionally removed from, the flat-panel display independently of the latter's enclosure configuration, since flat-panel displays usually have, between the display module and its enclosure, narrow gaps into which the fastening lug 8 can be inserted.

Such an optical assembly 5 can be made easily and cost-effectively. The optical assembly 5 is particularly user-friendly, firstly, in that it can be attached to the flat-panel display by a user having no significant prior knowledge. Secondly, it can be removed from the flat-panel display again, in that the attachment procedure is followed in the reverse order.

To ensure the widest possible use of the structured plate 1, it is preferably designed so that it can be positioned within enclosure extensions of the flat-panel display that jut out from the display module of the flat-panel display towards the observer.

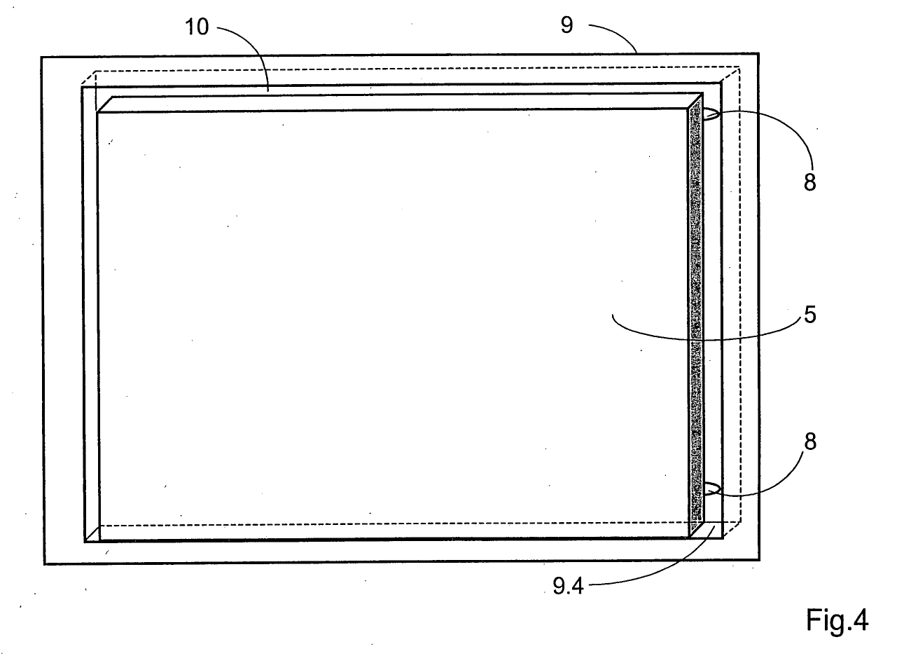

According to FIG. 4, this is accomplished, in particular, by designing the structured optical plate 1 in such a way that the outer dimension of its large front and rear surfaces 1.1, 1.2 are smaller than or equal to the dimensions of the recess 10 formed by the enclosure extensions 9 on the enclosure of the flat-panel display. The recess 10 is thus bordered on its sides by enclosure extensions 9 usually provided on flat-panel displays, and on the rear by the display module.

FIG. 4 particularly illustrates the principle of attaching an optical assembly 5 to a flat-panel display. As shown, the optical assembly 5 with its structured plate 1, which usually has the greatest volume contained in it, is inserted in such a recess 10, wherein the fastening lugs 8 are provided for the purpose of fastening the optical assembly 5 to the flat-panel display, in that these fastening lugs 8 are pushed between two components of the flat-panel display, preferably—as illustrated here—between a segment of the display module and a segment of the enclosure, which segment here is represented by the right margin of the enclosure extension 9. The display module is not explicitly shown in the drawing, but it can be imagined as the rear boundary of the recess 10.

Good mechanical stability is achieved if the outer geometry of the optical assembly 5 is dimensioned so that one or several of its narrow edge faces 7.1, 7.2, 7.3 and 7.4 rest on or against segments of the enclosure of the flat-panel display, especially the enclosure extensions 9. Especially eligible for this is the enclosure extension 9.4 at the bottom side of the image surface of a flat-panel display, as shown in FIG. 4; but the optical assembly 5 may just as well rest against a right-hand or left-hand or upper side of the enclosure extension 9.

Preferably, the large surfaces 1.1, 1.2 of the structured plate 1 are essentially rectangular in outline, as shown in FIG. 3 and FIG. 4. The large surfaces 1.1, 1.2 should be dimensioned to be larger than or at least equal to the image surface of the display modules to which the optical assembly 5 is to be attached.

Further, it is favorable if the optical assembly 5 is provided with two or more fastening lugs 8, which jut out from at least two of the narrow edge faces 7.1, 7.2, 7.3 or 7.4.

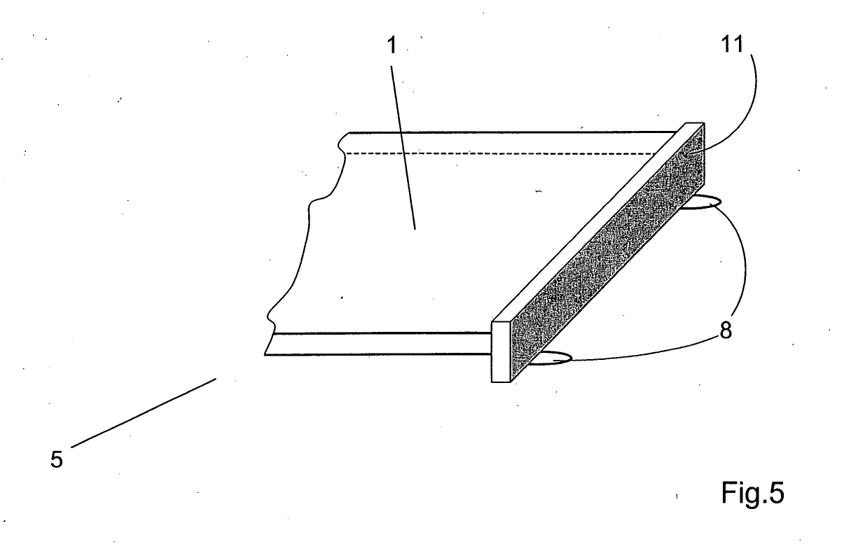

FIG. 5 shows another advantageous embodiment of the optical assembly 5, in which a frame 11 is provided, which doubles as a spacer between the structured plate 1 and the display module. The fastening lugs 8 are rigidly fixed to the frame 11, on the side facing the flat-panel display. Thus, the fastening lugs 8 jut out from the frame 11 rather than on the narrow side of the structured plate 1 alone. The frame 11 has, for example, a groove (not shown in the drawing) in which the structured plate 1 is rigidly mounted.

FIG. 5 is merely a detail sketch illustrating the principle. In practice, the frame 11 will usually be provided around all four sides of the structured plate 1. The frame 11 may be made, e.g., of commercial metal sections or of plastic.

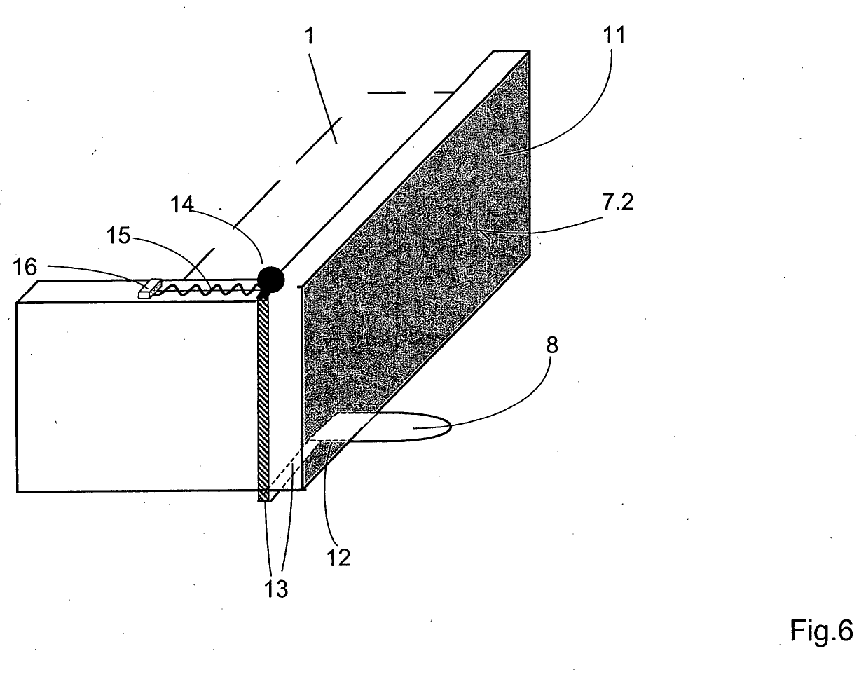

Another, highly advantageous embodiment of the optical assembly 5 is illustrated in FIG. 6. The drawing is not to scale and shows a small portion only of the optical assembly 5. Of the several fastening lugs 8 provided, only one is shown here.

At least one of the fastening lugs 8 is movably connected to the structured plate 1 via a mechanical sliding device so that, when the optical assembly 5 is being attached to a flat-panel display, the fastening lug 8 can be brought into such a position relative to the structured plate 1 in which it does not significantly jut out from a narrow edge face (here, narrow edge face 7.2) or from the frame 11, and that, for reversible fastening of the optical assembly 5 to the flat-panel display, the fastening lug 8 can be brought into such a position relative to the structured plate 1 in which it juts out from the narrow edge face 7.2 or from the frame 11 and is located between two components of the flat-panel display.

Such a sliding device may comprise, for example, at least one slide rail 12 (not shown in detail in the drawing). Also provided are connecting plates 13 provided, which mechanically connect the fastening lug 8 to a handle 14, which allows the fastening lug 8 to be moved manually. Preferably, each of the fastening lugs 8 movably connected to the structured plate 1 is provided with such a handle 14.

The connecting plates 13 can be made from thin sheet metal or other materials, e.g., plastic at low cost. The slide rail 12 may either be integrated in the frame 11 as a guiding groove or provided at the bottom side of the frame 11 in the form of sheet metal sections. Other configurations are feasible as well. The decisive point is that the slide rail guides the movement of the respective fastening lug 8, preferably along a straight line.

FIG. 6 also shows a further advantageous detail of the configuration of movable fastening lugs 8: The optical assembly 5 can be used with still greater ease if the mechanical sliding device comprises, for at least one of the fastening lugs 8, a restoring element 15, such as, e.g., a spring. This restoring element 15 is connected to the frame 11 via a holder 16 and, with no external force applied, gets the fastening lug 8 into a certain position relative to the structured plate 1, preferably a relative position in which the fastening lug 8 juts out from one of the narrow edge faces 7.2.

For fastening the optical assembly 5 to the flat-panel display, the user merely needs to retract the fastening lug 8, thus getting it into a relative position in which the fastening lug 8 does not jut out from the narrow edge face 7.2. Once the optical assembly 5 has been placed in position against the flat-panel display, it is sufficient to let go of the handle 14 to fix the optical assembly 5 to the flat-panel display.

The restoring element 15 moves the fastening lug 8 back to a position relative to the structured plate 1 in which it juts out from the narrow edge face 7.2 or from the frame 11, and is pushed in between an enclosure segment 9 and the display module of the flat-panel display, thus fastening the entire optical assembly 5 to the flat-panel display.

Several movable fastening lugs 8 may be mechanically connected to a single handle for convenient manipulation. Moreover, it is feasible that the fastening lug 8, if connected to a restoring element 15, clicks in (and out again) in the relative position in which it does not jut out from the narrow edge face 7.2. To disengage the lug, the user would move the respective handle 14. An optical assembly 5 may be provided with several movable fastening lugs 8 that can be moved simultaneously by the user with a single handle 14.

In this way, the process of attaching the optical assembly 5 to the flat-panel display is facilitated for the user, since, when the optical assembly 5 is placed against the flat-panel display, not necessarily all existing fastening lugs 8 jut out from the respective narrow edge faces 7.1 through 7.4 or from the respective frame 11. The same applies to detachment from the flat-panel display.

The structured plate 1 preferably comprises a wavelength filter array. Wavelength filter arrays are known to the specialist from, e.g., DE 100 03 326 C2, WO 01/56265 A and DE 201 21 318 U1.

With the optical assembly 5 attached to the flat-panel display, the wavelength filter array defines certain propagation directions for the light emitted by the individual pixels, with each pixel corresponding to several wavelength filters correlated to it, or each wavelength filter corresponding to several pixels correlated to it, in such a way that the straight line connecting the centroid of the cross-section area of a visible segment of the pixel and the centroid of the cross-section area of a visible segment of the wavelength filter corresponds to one propagation direction. The propagation directions intersect at a plurality of observation positions.

For that reason, and provided that the display module renders an image combined of at least two views of a scene/an object, an observer will see, from any observation position, predominantly bits of partial information of a first selection from the views with one eye, and predominantly bits of partial information of a second selection from the views with the other eye, so that, from a plurality of observation positions, the observer is given a 3D impression.

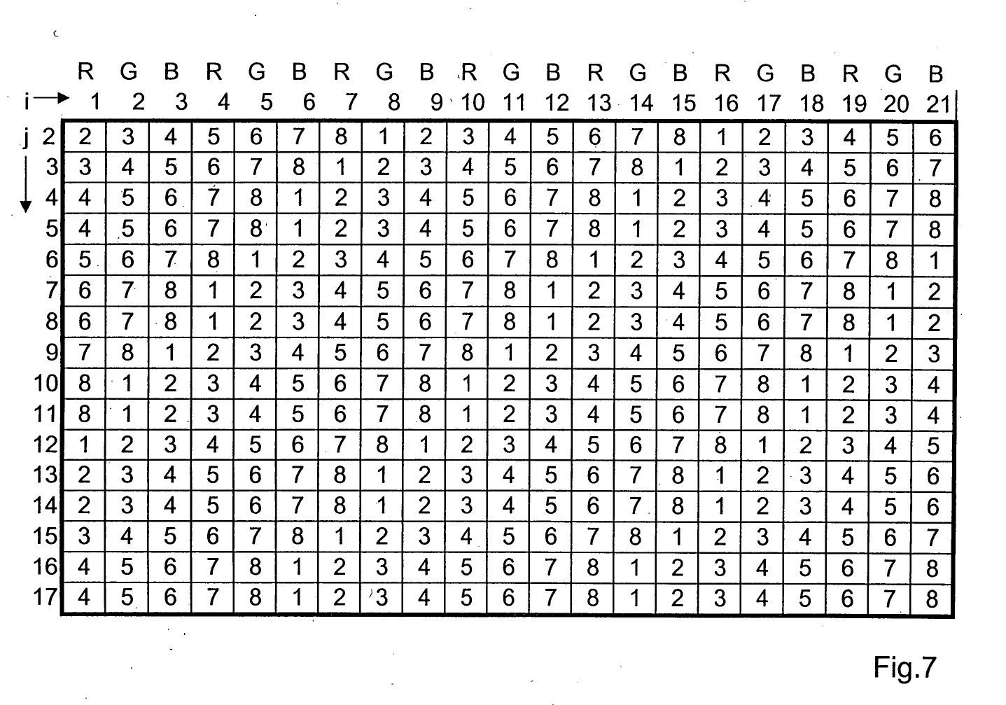

An example of the possible structure of such a combined image, hereafter called image combination, is shown in FIG. 7. By way of example, this structure or image combination suitable for 3D representation is shown composed of eight views here. The pixels in the R, G and B columns render image information in the colors red, green and blue of the respective views. The boxes, which represent the pixels, identify the numbers of the views from “one” to “eight”, from which the respective pixel obtains its image information of the corresponding pixel position, as described in detail in DE 100 03 326 C2 and elsewhere.

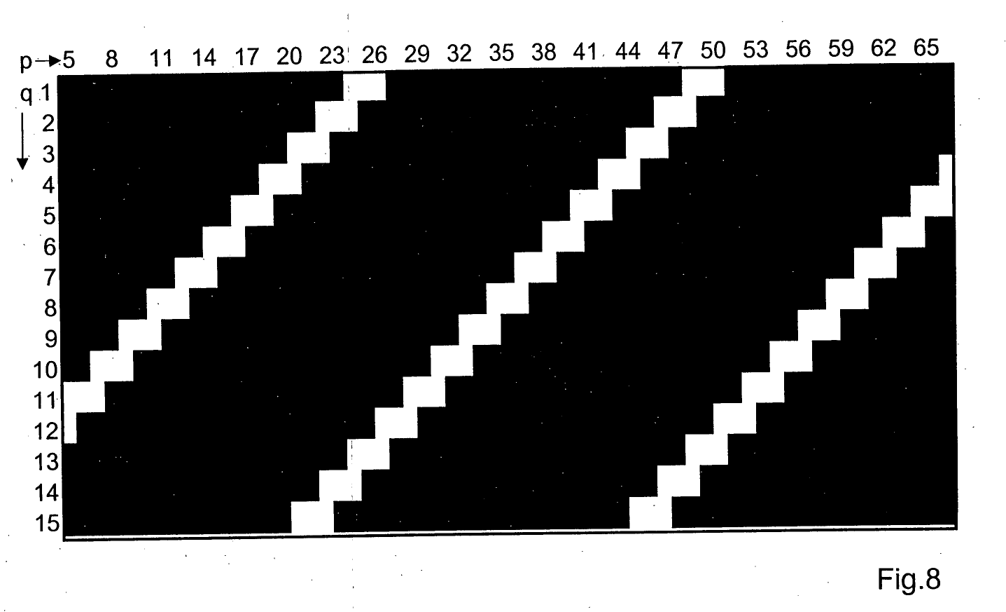

Further, FIG. 8 shows an example of the structure of a wavelength filter array, which is well suitable for 3D representation together with the image combination structure shown in FIG. 7. Same as FIG. 7, FIG. 8 only shows a portion of the respective structure. Accordingly, the wavelength filter array contains only transparent and opaque filter elements in rows q and columns p.

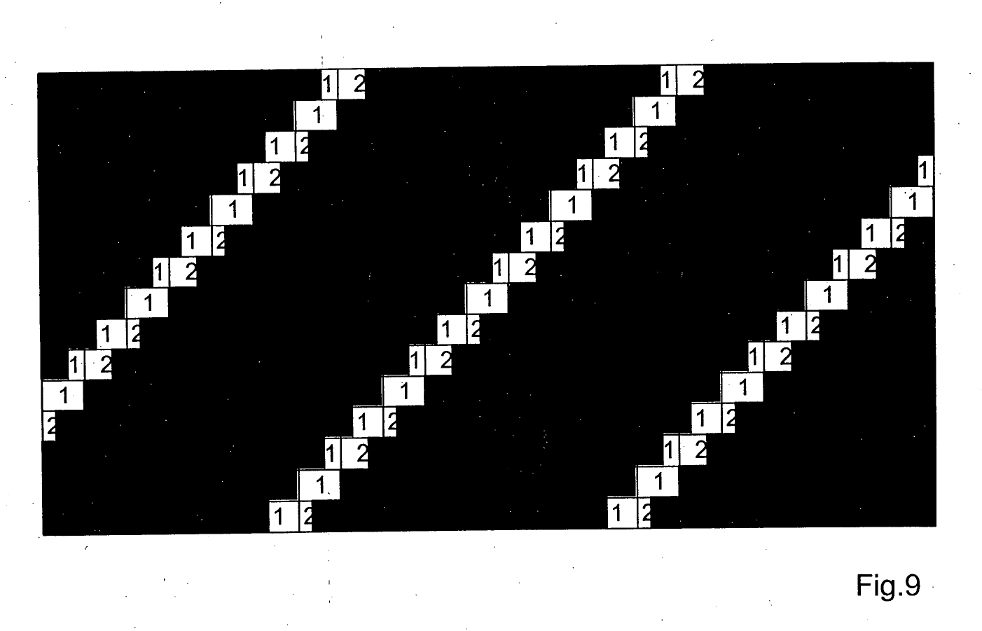

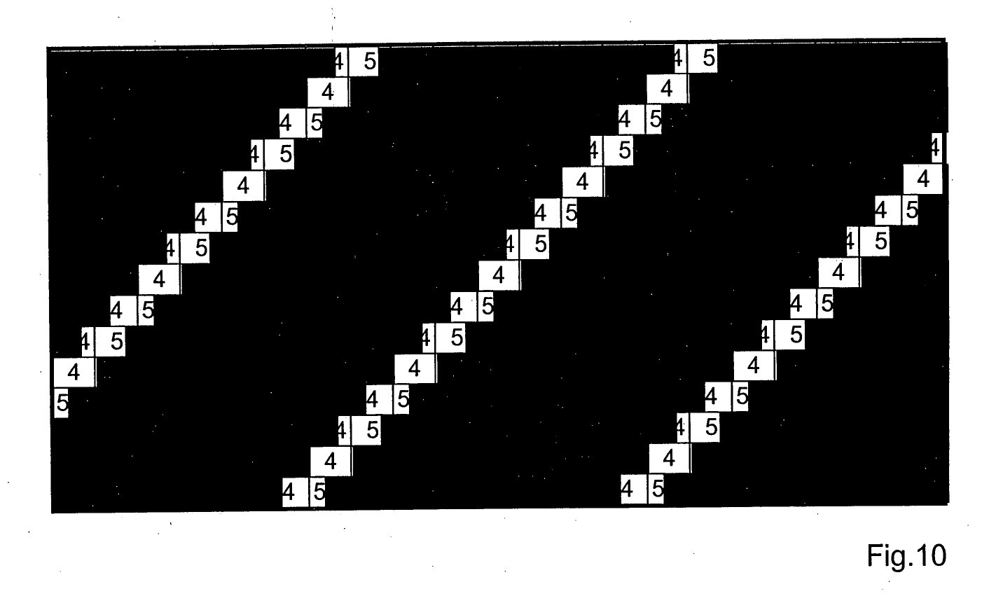

FIG. 9 and FIG. 10 show examples of possible view mixes visible to the right and the left observer eye, respectively, based on a wavelength filter array according to FIG. 8 and an image combination structure according to FIG. 7 Thus it illustrates how the 3D impression comes about.

In the filter array according to FIG. 8, λ₄ . . . λ₂₄ are wavelength ranges that block the entire visible spectrum, with reference to function F2 in WO 01/56265 A; λ₁ . . . λ₃ are wavelength ranges transparent to the visible spectrum; furthermore, bₘₐₓ=24, nₘ=24, and

$${d}_{pq} = \frac{p - ( IntegerPart ( p + 2 \cdot q - 1 ) mod 24 + 1 )}{q}$$

Here, a transparent or opaque filter element is, for example, approximately 0.032 mm wide and approximately 0.298 mm high, with other dimensions being feasible. Since, as a rule, three transparent filters are adjoining horizontally, every one of the transparent boxes shown in FIG. 8 corresponds to the direct combination of three transparent filters, such a combination having a width of about 0.096.

For the image combination structure according to FIG. 7, there apply the following parameters, with reference to function F1 in WO 01/56265 A:

$${c}_{ij} = \frac{ⅈ - [ ( IntegerPart ( ⅈ + j \cdot \frac{2}{3} - 1 ) mod 8 ) + 1 ]}{j}$$

and n, the number of views equals 8.

Another embodiment of the optical assembly 5 that is advantageous with regard to the structure of the wavelength filter array and the respective image combination structure to be presented on the flat-panel display is described below.

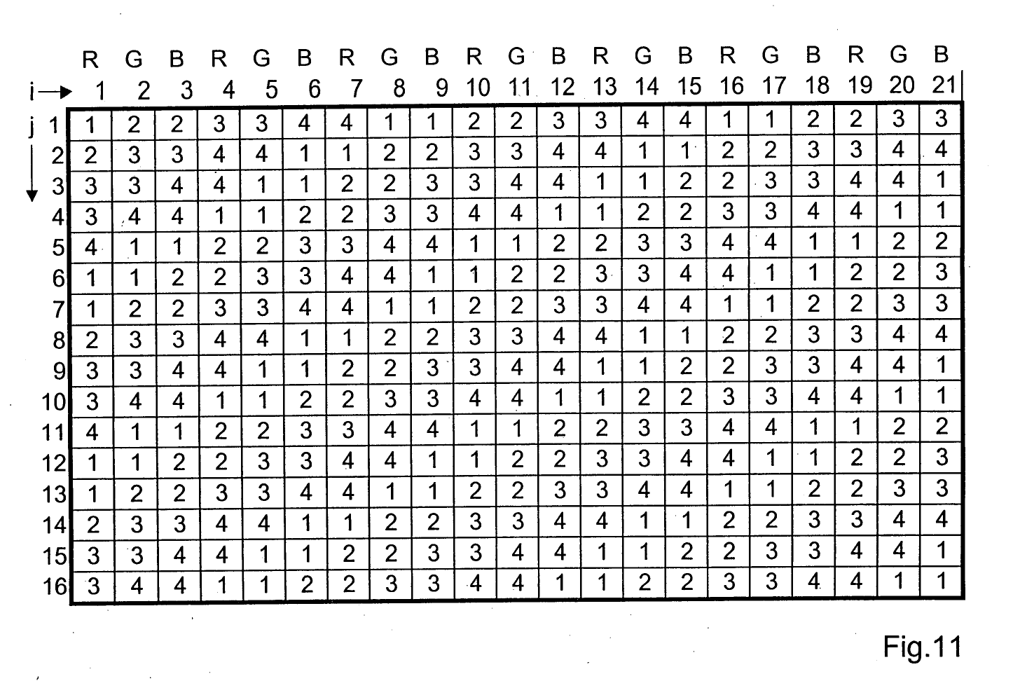

FIG. 11 shows another possible structure of such an image combination. The image combination shown here is composed, by way of example, of four views and also suitable for 3D representation.

For the image combination structure according to FIG. 11 there apply the following parameters, with reference to function F1 in WO 01/56265 A:

$${c}_{ij} = \frac{ⅈ - [ ( IntegerPart ( ⅈ \cdot \frac{1}{2} + j \cdot \frac{2}{3} - 1 ) mod 4 ) + 1 ]}{j}$$

and n equals 4.

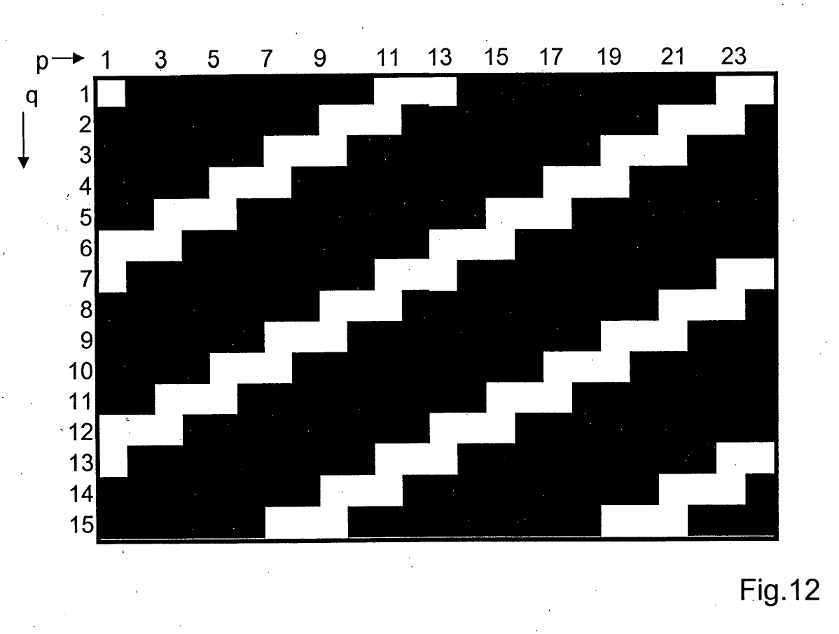

Further, FIG. 12 shows an example (not to scale) of the structure of a wavelength filter array that is suitable for 3D representation together with the structure of an image combination shown in FIG. 11. Same as FIG. 11, FIG. 12 shows only portions of the respective structure.

Accordingly, the wavelength filter array contains only transparent and opaque filter elements in rows q and columns p.

In the filter array according to FIG. 12, λ₄ . . . λ₁₂ are wavelength ranges that block the entire visible spectrum, with reference to instruction F2 in WO 01/56265 A; λ₁ . . . λ₃ are wavelength ranges transparent to the visible spectrum; furthermore, bₘₐₓ=12, nₘ=12, and

$${d}_{pq} = \frac{p - [ ( ( p + 2 \cdot q - 1 ) mod 12 ) + 1 ]}{q}$$

Here, a transparent or opaque filter element is, for example, approximately 0.064 mm wide and approximately 0.298 mm high, with other dimensions being feasible. Since, as a rule, three transparent filters are adjoining horizontally, every one of the transparent boxes shown in FIG. 12 corresponds to the direct combination of three transparent filters, such a combination having a width of about 0.192 mm.

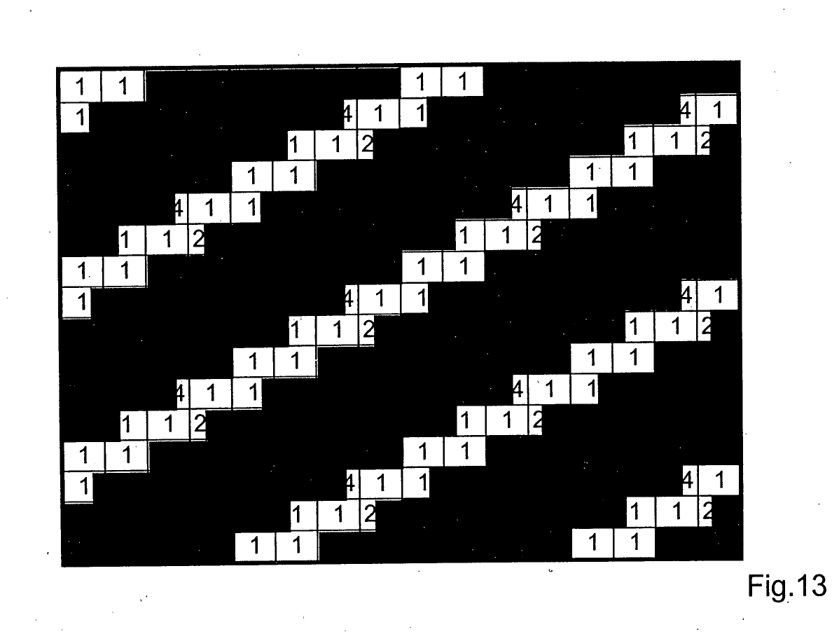

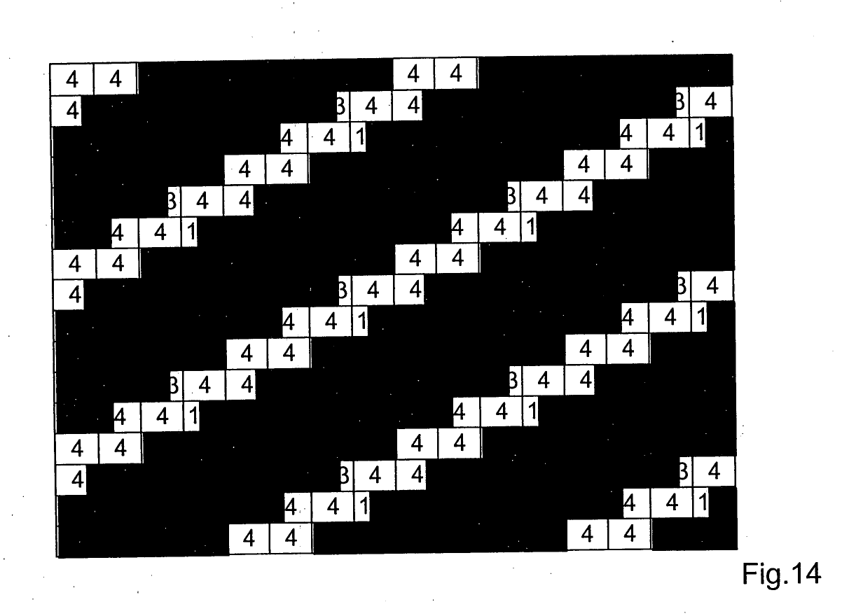

FIG. 13 and FIG. 14 show examples of possible view mixes visible to the right and the left observer eye, respectively, based on a wavelength filter array according to FIG. 12 and an image combination structure according to FIG. 11. Thus it illustrates, for this case, too, how the 3D impression is brought about.

To convert a flat-panel display into an autostereoscopic screen with little effort and at low cost, another method can be applied, using the optical assembly 5 described above:
Manufacturing or provision of an optical assembly 5 satisfying at least one of the claims herein,
Manufacturing or provision of a flat-panel display with at least a display module and an enclosure, the enclosure extension 9 of which forms a recess 10 that is sufficiently large to receive a part or most of the structured plate 1 of the optical assembly,
Permanent fastening of the optical assembly 5 to the flat-panel display by pushing at least one of the fastening lugs 8 provided on the optical assembly 5 between two components of the flat-panel display, preferably between a segment of the display module and a segment of the enclosure.

With the permanent fastening of the optical assembly 5 to the flat-panel display, the latter is converted virtually irreversibly into an autostereoscopic flat-panel display. Preferably, the step of permanently fastening the optical assembly 5 to the flat-panel display is supplemented by one of the following actions, which replace the last-named of the above steps:
Provision of an adhesive joint between at least one of the narrow edge faces 7.1, 7.2, 7.3 or 7.4 of the structured plate 1 and a component of the flat-panel display, using, for example, some double-face adhesive tape or some adhesive agent, and/or
Provision of an adhesive joint between the large rear surface (in viewing direction), e.g. the large area 1.2, or the frame 11 of the structured plate 1 and a component of the flat-panel display, using, for example, some double-face adhesive tape or some adhesive agent, with the double-face adhesive tape or adhesive agent being applied, e.g., to the frame 11 of the structured plate 1 before attaching the optical assembly 5 to the flat-panel display, and/or
Provision of an adhesive joint by applying some fluid as, e.g., cedarwood oil, between the structured plate 1 or its frame 11 and a component of the flat-panel display, and/or
Provision of a firm joint between the structured plate 1 and the flat-panel display by soldering or welding.

The method versions described before can optionally be supplemented by another step following the respective step of fastening the optical assembly 5 to the flat-panel display, viz.:
Adjustment of the position of the structured plate of the optical assembly 5 relative to the display module of the flat-panel display.

Such an adjustment of the relative position can be of advantage especially if an edge of the structured optical plate 1 and a neighboring edge of the image area of the display module are not aligned in parallel in the greatest possible degree. Preferably, the adjustment is carried out as described before.

To align, for example, an optical assembly 5 with a structured plate 1 comprising a wavelength filter array according to FIG. 8 to a display module, it is of advantage if the test image is an image combination structure with eight views according to FIG. 7, in which, for example, views “two” to “eight” form a completely black area, whereas view “one” forms a completely red area.

The aim of the adjustment should be to find a position of the structured plate 1 relative to the display module of the flat-panel display in which there is a visible red area of maximum extent within the visible monocular image.

Analogously, a structured plate 1 provided with a wavelength filter array according to FIG. 12 would preferably be aligned using an image combination structure for the test image according to FIG. 11.

Optionally, all methods and method versions described before can be supplemented by another step also mentioned before:
Presentation of an image combined from several views of a scene and/or object on the display module to obtain an autostereoscopic presentation.

Specialists know how an image combined from several views can be obtained; reference is made again to WO 01/56265 A.

The expanded presentation of an image combined from several views of a scene and/or object as disclosed in DE 101 45 133 C1 is of particular importance if a single optical assembly 5 with a structured plate 1 is to be compatible with several different display modules having differing horizontal and/or vertical pixel periods (“pixel-pitches”). In this case, the image composed of several views can be adapted to the ratio between the filter element periods on the filter structure and the pixel periods on each respective display module.

The practical advantage consists especially in the fact that a single type of the optical assembly 5 can be used for different types of display modules, especially such having differing pixel periods (“pixel-pitches”). Adaptation of the presentation of an image combination is then performed by a suitable software.

Further, when an image combined from several views of a scene and/or object is presented on the display module, image combination may be effected in such a way that any undesirable rotation (i.e. non-parallelism) of a preferred direction of the pixels, e.g., the pixels arranged in columns, relative to a quasi-parallel preferred direction of an array on the structured plate 1, e.g., the filter elements arranged in columns, is compensated to the greatest possible extent by a corresponding complementary rotation of the image presented by the pixels.

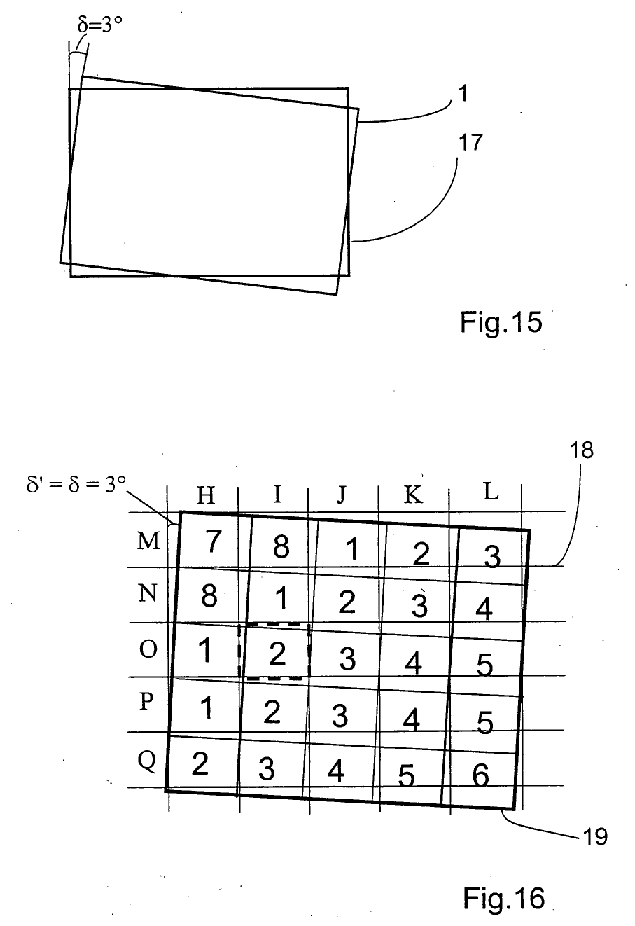

The corresponding rotation of the image presented may be effected using the approach described above, which simultaneously correlates image information from two different views to at least one physically smallest pixel. This will now be explained in detail with reference to FIG. 15 and FIG. 16.

FIG. 15 is a schematic representation of a case in which the structured optical plate 1 is attached to the flat-panel in a position rotated relative to it. The rotation is shown with an angle of δ=3°, i.e. grossly exaggerated for purposes of illustration. Such a rotation would occur, for example, if an optical assembly 5 were attached to a flat-panel display and rested against an inner side of an enclosure extension, e.g., 9.4 (see FIG. 4), whose principal extension were slightly rotated relative to the row (or column) direction of the display module due to a manufacturing defect. Typically, a rotation angle thus caused would have an absolute value of 1° or less, although a larger absolute value is feasible as well.

Compared to this, FIG. 15 shows a rotation angle of δ=3° between the vertical edge of the structured plate 1 and the vertical dimension of the pixels of the schematically indicated display module 17. As a rule, a 3D display under these circumstances would suffer a quality impairment or not be possible at all. In such a case, the image can be rotated as described.

FIG. 16 is a sketch illustrating the principle of how the rotation sketched in FIG. 15 can be corrected by means of an appropriately modified image content. The columns H, I, J, K and L represent the columns of the pixels, and the rows M, N, 0, P and Q represent the rows of the pixels of the display module 17 in the matrix 18. The schematic rotated matrix 19 consisting of columns and rows of virtual pixels and defining the image combination structure is aligned in such a way that its column or row direction preferably implements the said rotation δ, and that the second rotation angle δ′=δ now regarded in FIG. 16 exists between the matrix 18 of the pixels, consisting of the columns H through L and rows M through Q, and the rotated matrix 19 of virtual pixels. In the case illustrated, we have δ′=δ=3°.

To generate the appropriately rotated image content and thus to improve the 3D presentation, if not to make 3D presentation possible at all under these circumstances, the image content of the actual pixels of the display module 17 in columns H through L and rows M through Q is generated in such a way that, corresponding to the respective rotation as shown in FIG. 16, the image information is determined for each individual pixel of the matrix 18 and then presented by the pixels of the display module 17.

The actual pixels of the matrix 18 are identical in form and size to their corresponding virtual pixels of the matrix 19. This includes the possibility that, for example, red subpixels may differ in shape from green subpixels. The matrix 19 would then be established from virtual pixels allowing for this difference.

The image information for each individual virtual pixel of the matrix 18 preferably determined by projecting the virtual matrix 19 in its rotated position onto the matrix 18 of actual pixels arranged in columns H through L and rows M through Q, and determining, for each virtual pixel, the area shares of the respective views of the image combination structure on which the actual pixels are based.

In FIG. 16, for example, the pixel framed by broken lines in the second column and the third line of the matrix 18 would contain a mix of approximately 80% image information of view “two”, approximately 8% image information of view “one”, approximately 9% image information of view “one”, and approximately 3% image information of view “eight”.

If these views exist, the appropriately mixed image information for the specially regarded pixel of the matrix 18 can be easily calculated (e.g., as a weighted mean of the digital values for the respective image information). It should be minded that always the information from the correct R, G or B color channels must be obtained, i.e. if, for example, the regarded pixel (the one framed by broken lines) emits green light, green information has to be obtained from the nearest neighbor matrix cells.

Once the image information has been determined for all pixels of the matrix 18 by the procedure described, this information is presented on the matrix of actual pixels of the display module 17 of the respective flat-panel display.

Preferably this is done in that, as a relative alignment of the two matrices (matrix 19 and matrix 18 of actual pixels of the display module), the image information of the top left virtual pixel is imaged onto the top left actual pixel, as far as these two pixels comprise image information for the same wavelength. Other relative alignments are feasible as well.

Missing information for virtual or actual pixels at the edge of the respective matrix would be simply compensated, for example, by black image information.

Let it be remembered here that an actual matrix of pixels of a display module used in practice has significantly more rows and columns than shown in FIG. 16. If, for example, a 15″ LCD display with XGA resolution and RGB color subpixels were used, it would have, for example, 1024*3=3072 columns and 768 rows. A corresponding matrix of virtual pixels would contain about just as many pixels.

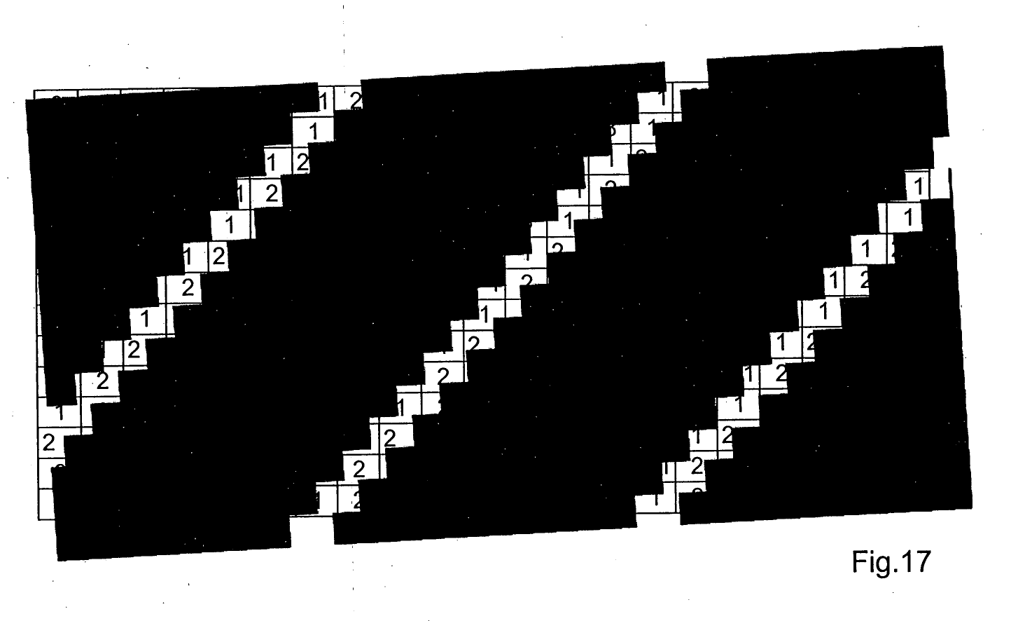

Another approach to compensating a possible rotation is described below in detail with reference to FIGS. 17 through 21. The description is based on the assumption that the structured optical plate 1 is provided with a wavelength filter array according to FIG. 8.

FIG. 17 is a detail sketch illustrating the principle of a possible mix of views visible to one eye of an observer for the case that a wavelength filter array is attached to the flat-panel display in a rotated position. Here again, for easier understanding, the rotation between the filter array and the display module of the flat-panel display, or strictly speaking, between the column direction of the filter elements on the filter array (parallel to the left edge of the filter array) and the column direction of the pixels, is shown with an angle of approximately δ=3°, i.e. grossly exaggerated.

FIG. 17 shows that the observer's eye does indeed see a mix of certain dominating views at first. However, if the area of the drawing is enlarged and things are considered in a larger context, it will be found the observer's eye sees equal shares of all eight views, so that, if the observer's other eye sees a similar mix of views, a satisfactory 3D effect will not necessarily be obtained.

When an image combined from several views of a scene and/or object is presented on the display module, image combination is effected in such a way that a rotation of a preferred direction of the pixels of the monitor, for example, the columns of pixels, relative to a quasi-parallel preferred direction of a matrix on the structured plate, for example, the columns of filter elements, is compensated to the greatest possible extent in that the horizontal and/or vertical period of the views in the respective image combination structure intended for the image shown by the monitor pixels is varied in such a way that a preferred direction defined by a sequence of nearest-neighbor positions of bits of image information of one and the same view on the varied image combination structure is situated approximately parallel to a preferred direction defined by a sequence of non-opaque nearest-neighbor filter elements on the wavelength or neutral-density step filter array.

As a rule, this makes it necessary that—as mentioned before—image information of two different views are simultaneously correlated to at least one pixel, in order to achieve the correspondingly varied image combination structures with suitably varied horizontal and/or vertical periods of the views.

For an explanation in greater depth, reference is made again to FIG. 7 first. This shows an image combination structure that can be advantageously used for a filter array according to FIG. 8. This image combination structure underlies the illustrations according to FIGS. 17 through 19, and FIG. 21.

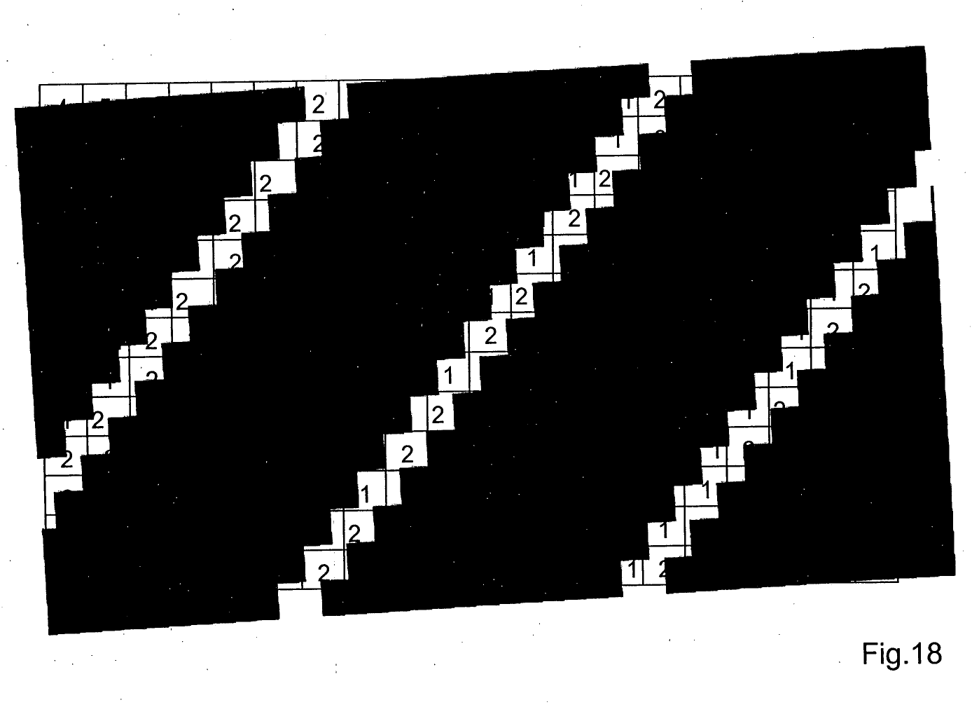

FIG. 18 now is a sketch illustrating the principle of correcting the rotation sketched in FIG. 17 by means of a modified image combination structure. Here, the image combination structure shown in FIG. 7, which there corresponds, for example, to exactly one pixel per box, has been expanded in height by a factor of 1.27. The size of the pixels themselves remains unchanged; what is expanded is the structure.

Because of this expansion, the preferred direction defined by a sequence of nearest-neighbor positions of bits of image information of one and the same view (e.g., of view “one”) has been changed. It is now approximately parallel to the preferred direction defined by a sequence of non-opaque nearest-neighbor filter elements on the wavelength or neutral-density step filter array.

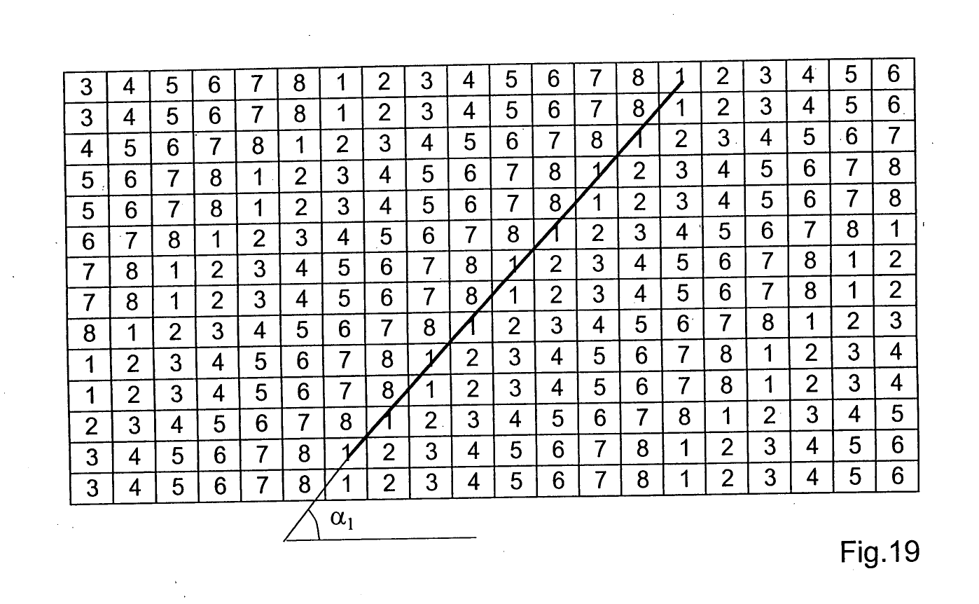

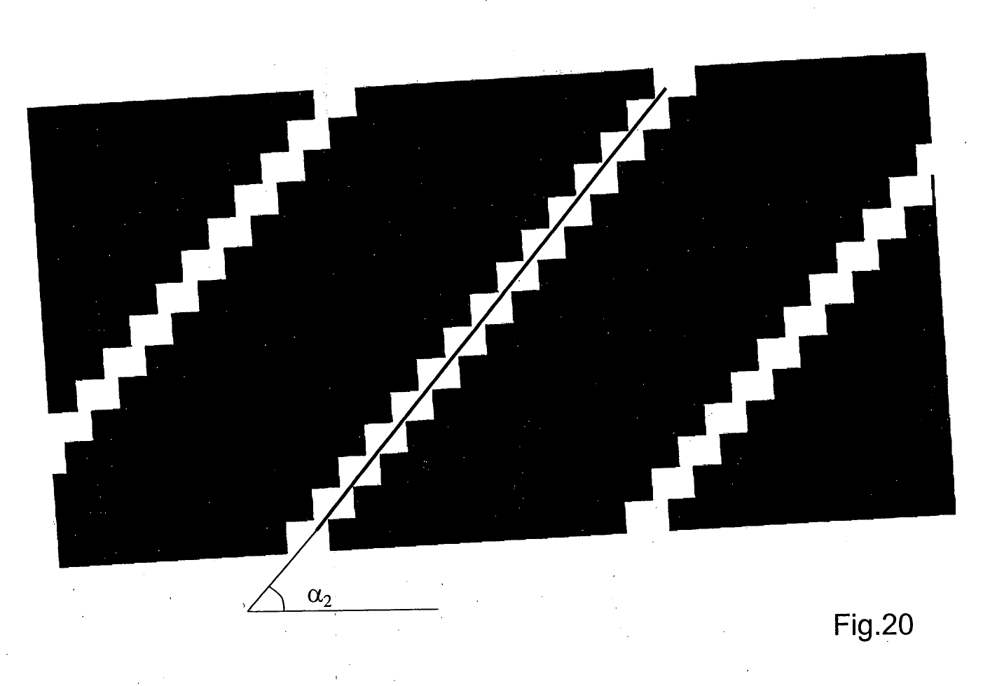

The factor of 1.27 chosen as an example was determined as follows: FIG. 19 is a detail sketch illustrating the principle of a preferred direction defined by a sequence of nearest-neighbor positions of bits of image information of one and the same view (here: view “one”). This preferred direction is marked by the oblique bold line. Here, it forms a slope angle with the horizontal of, for example, α₁.

Compared to this, FIG. 20 is a sketch illustrating the principle of a preferred direction defined by a sequence of non-opaque (here: transparent) nearest-neighbor filter elements. This preferred direction is also marked by an oblique bold line. Here, it forms a slope angle with the horizontal of, for example α₂. Because of the said rotation between filter array and pixels by which an image is presented that is combined according to the image combination structure shown in FIG. 7, α₁≠α₂. It is desirable, however, that the slope angles α₁ and α₂ be equal so as to improve the quality of the 3D presentation. The slope α₁ is now changed as described above by expanding the image combination structure in height according to FIG. 19 until the modified slope angle α₁′ equals the slope angle α₂. The measure of the expansion can easily be derived from the ratio of the tangents of the angles α₂ and α₁; here it corresponds, e.g., to the factor of 1.27. This results, for example, with α₁=47° and α₂=α₁′=53.70, from tan α₂/tan α₁=1.27.

The vertical expansion of the image combination structure approximately corresponds to the use of a density factor for this direction of 1/1.127=0.7874, and thus to an expansion factor in the column direction, as described in DE 101 45 133 C1.

Besides a vertical expansion, a vertical contraction would be feasible, too. A horizontal scaling of the image combination structure would be possible as well.

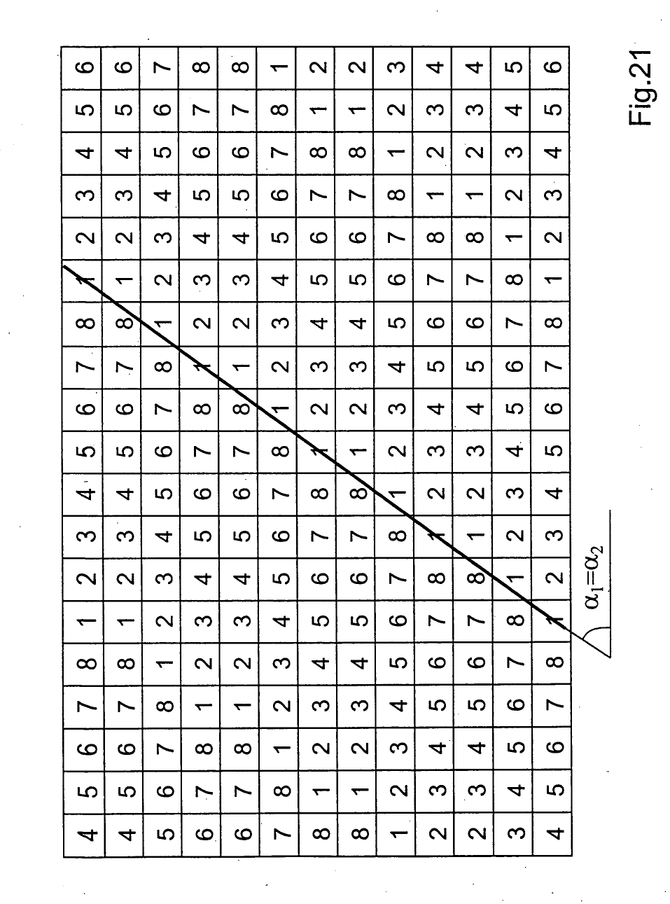

FIG. 21 is a sketch illustrating the principle of a preferred direction defined by a sequence of nearest-neighbor positions of bits of image information of one and the same view, in which equalization of the angles of the preferred directions (α₁′=α₂) was achieved as described above. Of course, the varied image combination structure is to be understood as a virtual one, i.e. it satisfies an image combination instruction that is usually presented by pixels of a display module that have dimensions different from the smallest pixels of the modified image combination instruction (here corresponding to the boxes containing the view numbers).

Accordingly, the matrix of the modified image combination instruction has to be projected onto the actual matrix of pixels, and, according to area shares, one pixel each of the monitor with correspondingly weighted bits of image information of typically different views has to be driven in order to practically implement the modified image combination instruction.

Further, it is possible in principle both to compensate a rotation in the sense described above, and to carry out an adaptation of the pixel period to a certain structure period on the structured plate 1, e.g., the transparent filter element period as described above, by the sole measure of modifying the image combination structure. With this, it would not be absolutely necessary, though possible, to simultaneously correlate image information of two different views to any one pixel.

Moreover, it is feasible to code the 3D presentation by specifying, for the respective structure on the structured plate 1, e.g., for a wavelength filter array, a coding key for shifting the various filter elements, and using, for the respective image combination structure of the image content to be shown on the flat-panel display to be used, a suitable decoding key especially for shifting the positions of the respective views from which the bits of pixel information originate.

The procedure, which is described in DE 101 18 461 C2, is used to prevent pirate copying of hardware and software. A 3D presentation cannot be obtained then from of a coded wavelength filter array integrated in a structured plate 1 save by a user who knows the appropriate decoding key.

Finally, another advantageous and especially practical example of an embodiment of the optical assembly 5 is described here. In this embodiment, the optical assembly 5 can be used for a wide variety of different 15″ LCD screens (each with an aspect ratio of 4:3) having a suitable enclosure extension. Such 15″ flat-panel displays usually have visible image area dimensions of 307.2 mm×230.4 mm, or 304.1 mm×228.1 mm (width×height), such as, e.g., displays of model “Philips 150B”.

The structured plate 1 of the optical assembly 5, or strictly speaking, the large front surface 1.1 and the large rear surface 1.2, are rectangular in shape with dimensions of, e.g., 300 mm width×224 mm height (or a few millimeters less in either direction).

The structured plate 1 consists of a wavelength filter array laminated or printed onto a substrate. This filter array is provided on the large surface 1.2 of the structured plate. The substrate is, for example, a glass pane, preferably of a thickness of approximately 1.5 mm to 2 mm. If the filter array is laminated on, it may be fabricated previously as an exposed photographic plate or film.

The wavelength filter array has the basic structure shown in FIG. 8, with one column of the (p,q) matrix shown having a width of approximately 33.2 μm, and one row having a height of approximately 299 μm. Slight variations of these dimensions by up to +/−2 μm may sometimes be of advantage. The filter array structure essentially occupies the entire large surface 1.2. Adaptation of the images to different sizes of display modules is possible by expansion or densification.

Also provided is a frame 11, which mounts the structured optical plate 1 by means of a groove extending all around the narrow edge faces 7.1 through 7.4. The frame 11 is made of metal, e.g., aluminum, or of plastic; it protrudes from each of the narrow edge faces by approximately 2 mm. At its top and bottom sides, the frame 11 has a width of approximately 4 mm. Accordingly, the structured plate 1 engages with the groove by approximately 2 mm on either side.

Depthwise, the frame 11 is designed to protrude from the large front surface 1.1 towards the observer by approximately 0.5 mm. Further, the frame protrudes from the large rear surface 1.2 in the direction away from the observer by approximately 1.6 mm. In that way, the frame 11 doubles as a spacer between the display module and the structured optical plate 1.

Such a frame also improves the stability of the optical assembly 5, since potential mechanical loads, such as external forces, will not essentially act on the structured plate 1 alone but also on the said frame 11.

Further, two fastening lugs 8 are rigidly fixed to the bottom side of the frame 11 of the structured optical plate 1, approximately behind the narrow side 7.4 (in viewing direction).

The fastening lugs 8 are designed as thin metal plates approximately 2 mm wide and approximately 0.2 mm thick, which jut out sideways from the frame 11 by approximately 4 mm. The fastening lugs 8 do not, however, jut out from the frame 11 in the direction toward the structured plate 1, so that they do not protrude into the visible image area of the display module and thus do not obscure any pixels.

In such an embodiment of the optical assembly 5, a few of the pixels situated at the outer margins of the display module are obscured by components of the optical assembly 5, here especially by the frame 11. This slight disadvantage, however, is more than compensated by the comprehensive advantages of the invention as described below.

In another embodiment of the invention, an optical assembly is employed that comprises at least the following components:
a structured plate 1 with dimensions of 250 mm×350 mm×2 mm,
a ferromagnetic component configured as a frame of iron, which is rigidly connected to the structured optical plate 1 and mounts it at its outer edges, which engage with the frame by a few millimeters, and
two strip-shaped permanent magnets, each of which has an adhesive face for their permanent adhesive joining to the enclosure of a flat-panel display,
   which allows the optical assembly to be fastened detachably (temporarily) to the flat-panel display by putting the ferromagnetic component of the structured plate 1 against the two strip-shaped permanent magnets.

Preferably, the strip-shaped permanent magnets are adhesively joined to the right and left of the display surface of a 15″ TFT-LC display.

Here, the structured plate 1 comprises, for example, a glass substrate approximately 1.9 mm thick with a wavelength filter array laminated on it. The filter array consists of a fully exposed and fully developed photographic film, e.g., of the type AGFA Alliance HN 0.1 mm, which, for example, has one of the filter array structures described in DE 201 21 318 U1 already quoted. Other filter structures are, of course, feasible as well.

The embodiment described above can be made at low cost and is easy to use.

The invention has several advantages over the prior art. The optical assemblies 5 can be attached to, and optionally detached from, the flat-panel displays irrespective of their makes They can be implemented easily and cost-effectively. For conversion by way of the optical assembly, the flat-panel display used requires no preparatory or subsequent treatment. No interference is required with the tried-and-approved processes of manufacturing the flat-panel displays.

The methods for establishing autostereoscopic flat-panel displays using the optical assemblies 5 can be implemented at low cost, especially because the establishment of an autostereoscopic flat-panel displays according to the invention can be accomplished without special enclosure designs and without having to open the enclosure of the originally 2D flat-panel display to be used. Moreover, the components for conversion, i.e., the said optical assemblies 5, can be manufactured at low cost. The invention is used industrially, e.g., in the field of 3D graphics.

In particular, the invention accomplishes, with simple and cost-effective means, the reversible fastening to a flat-panel display of an optical assembly suitable for separating partial images for monoscopic and autostereoscopic image display on flat-panel displays, the fastening being independent, to the greatest possible extent, of the enclosure design of the flat-panel display.

Finally it should be noted that the display modules may be designed for color or monochrome display.

1. Arrangement for the three-dimensional display of a object, in which a plurality of individual pixels in a matrix of columns and rows are made visible simultaneously and in which the pixels contain bits of partial information from more than two views of the object, comprising
a visual display device for the reproduction of the pixels, and
an optical assembly including a plurality of optical elements, and that is arranged between an observer and the visual display device, wherein
the optical elements are so positioned within the optical assembly that the light emerging from the pixels propagates in directions that intersect in observation positions from which bits of partial information of a first selection of views are visible to one eye, and bits of partial information of a second selection of views are visible to the other eye of an observer or of several observers,
in which
the visual display device and the optical assembly are detachably connected to each other by means of a fastening device, so that
fastening of the optical assembly to the visual display device converts the image display from monoscopic into autostereoscopic, while removal of the optical assembly from the visual display device converts the image display from autostereoscopic into monoscopic.

2. An arrangement as set forth in claim 1, in which
the optical assembly has a structured plate structures of which constitute the plurality of the optical elements,
the visual display device is a flat-panel display, and
further comprising means for influencing the air pressure between the structured plate and a surface of the flat-panel display, so that
generation of a partial vacuum between the structured plate and the surface of the flat-panel display fixes the optical assembly to the flat-panel display, and
generation of a normal or excess pressure between the structured plate and the surface of the flat-panel display detaches the optical assembly from the flat-panel display.

3. An arrangement as set forth in claim 2, in which the structured plate (1)
extends in two dimensions and
is mounted all around its outer edges in a frame that has one or more spacers for defined spacing of the structured plate from the surface of the flat-panel display, wherein
attaching the frame to a flat-panel display forms an essentially air-tight cavity between the structured plate and the surface of the flat-panel display.

4. An arrangement as set forth in claim 2, in which the means for influencing the air pressure between the structured plate and the surface of a flat-panel display comprises a pump, a valve or both a pump and a valve.

5. An arrangement as set forth in claim 3, in which the means for influencing the air pressure comprises a movable, airtight hem which is fastened to the frame and configured in such a way that, when it is pressed against the flat-panel display, a partial vacuum is generated between the structured plate and the surface of the flat-panel display so that the frame is fixed to the said flat-panel display.

6. An arrangement as set forth in claim 2, in which the means for influencing the air pressure further comprises a valve which, when required, effects a pressure equalization between the site of the partial vacuum and the outer atmospheric pressure, so that the optical assembly can easily be removed.

7. An arrangement as set forth in claim 2, comprising stripe-shaped segments comprising rubber, for sealing any joints against air leaking.

8. An arrangement as set forth in claim 1, in which
the visual display device is a flat-panel display, and
the means for fastening the optical assembly to the flat-panel display is an adhesive medium, in which
the adhesive medium absorbs the least possible amount of light.

9. An as set forth in claim 1, in which
the visual display device is a flat-panel display that comprises at least a display module and an enclosure, and
the optical assembly comprises a structured plate,
including structures that form a plurality of optical elements, and
the optical assembly having a large front surface and a large rear surface and narrow edge faces all around its sides, and
comprising at least one fastening element, which is rigidly or movably arranged at the structured plate and juts out from at least one of the narrow edge faces, wherein
fastening of the optical assembly is achieved by pushing the fastening element between two components of the flat-panel display, preferably between a segment of the display module and a segment of the enclosure.

10. An arrangement as set forth in claim 9, in which the structured plate can be positioned between extensions jutting out from the enclosure of the flat-panel display towards the observer, and in which the structured plate is dimensioned so that its outer edges contact the extensions.

11. An arrangement as set forth in claim 9, further comprising fastening lugs on at least one narrow edge face, at least one of these lugs being movable by means of a sliding a swiveling device or both, which, when the optical assembly is placed against the flat-panel display, does not jut out from the respective narrow edge face and which, for the purpose of fastening the optical assembly to the flat-panel display, can be slid or swiveled in such a way that it protrudes from one narrow edge face and is situated between the two components of the flat-panel display.

12. An arrangement as set forth in claim 9, further comprising at least one clamp fastened at one narrow edge face of the structured plate and used for clamping the optical assembly to the enclosure of the flat-panel display.

13. An arrangement as set forth in claim 1, in which
the visual display device is a flat-panel display, which comprises at least a display module and an enclosure,
the optical assembly comprising at least one structured plate, wherein the structures constitute the plurality of optical elements, and
magnetic means as a fastening device.

14. An arrangement as set forth in claim 13, which is provided with at least one ferro- or paramagnetic component rigidly or movably fastened to the structured plate, and at least one strip-shaped permanent magnet fastened to the enclosure of the flat-panel display, so that the optical assembly can be detachably fastened to the flat-panel display by contacting the ferro- or paramagnetic component with the permanent magnet, which holds it by attraction.

15. An arrangement as set forth in claim 14, in which the ferro- or paramagnetic component is configured as a frame that mounts the structured plate.

16. An arrangement as set forth in claim 2, in which the structured plate has an essentially rectangular outline with dimensions greater than or equal to the visible area of the display module of the flat-panel display, and in which the optical assembly is dimensioned so that its outer edges contact segments of the enclosure of the flat-panel display, especially enclosure extensions.

17. An arrangement as set forth in claim 2, in which the structured plate comprises a filter array, a lenticular screen, a barrier screen or a prism array with appropriately designed optical elements.

18. An arrangement as set forth in claim 17, in which the structured plate comprises a filter array with a plurality of wavelength filters, neutral-density step filters, polarizing filters or a combination of the foregoing, in which,
upon fastening of the optical assembly to the visual display device, one pixel each of the display module corresponds with several correlated wavelength, neutral-density or polarizing filters of the filter array and, conversely, one wavelength, neutral-density or polarizing filter of the filter array corresponds with several correlated pixels of the display module in such a way that
a straight line connecting a centroid of the cross-section area of a visible segment of the pixel with a second centroid of the cross-section area of a visible segment of the wavelength, neutral-density or polarizing filter corresponds to one propagation direction of the light emitted by the respective pixel,
the propagation directions intersect in a plurality of observation positions, and
from every observation position, an observer will see predominantly bits of partial information of a first selection with one eye and predominantly bits of partial information of a second selection of the views with the other eye,
so that, from a plurality of observation positions, the observer will have a 3D impression.

19. An arrangement as set forth in claim 18, in which the structured plate comprises a substrate with a wavelength filter array laminated or printed on it.

20. An arrangement as set forth in claim 2, comprising means for the movable holding of the structured plate, which are suitable for use in combination with a tracking unit for detecting the eye position of an observer or several observers.

21. An arrangement as set forth in claim 1 comprising means for adjusting the position of the optical assembly or the structured plate relative to the visual display device, wherein the means comprise, a screw micrometers, an eccentric mechanism or both.

22. A method for the temporary conversion of a flat-panel display into an autostereoscopic flat-panel display in which a plurality of individual pixels in a matrix of columns and rows are made visible simultaneously and in which the pixels contain bits of partial information from more than two views of the object, comprising
reproducing the pixels on a visual display device, and
arranging an optical assembly including a plurality of optical elements, before the visual display device so that the optical elements are so positioned within the optical assembly that the light emerging from the pixels propagates in directions that intersect in observation positions from which bits of partial information of a first selection of views are visible to one eye, and bits of partial information of a second selection of views are visible to the other eye of an observer or of several observers;
detachably connecting the visual display device and the optical assembly to each other by means of a fastening device, so that fastening of the optical assembly to the visual display device converts the image display from monoscopic into autostereoscopic, while removal of the optical assembly from the visual display device converts the image display from autostereoscopic into monoscopic.

23. A method as set forth in claim 22, further comprising the step of: after the fastening of the optical assembly to the flat-panel display, adjusting the position of the optical assembly, the structured plate or both relative to the flat-panel display.

24. A method as set forth in claim 23, in which the adjustment comprises the steps of:
presenting a test image on the flat-panel display, wherein the test image is an image composed of n views arranged in rows and columns, n being greater than two, with exactly n minus one of the views each corresponding to one completely black area each, and exactly one view corresponding to a completely white or completely blue or completely green or completely red area,
continuously shifting the position of the optical assembly or of the structured plate relative to the flat-panel display, and simultaneously visually inspecting the monocular images visible from an arbitrarily chosen but permanent monocular observation position until the shifting has resulted in a relative position in which the monocular image shows a white, blue, green or red area of maximum extension.

25. A method as set forth in claim 22 further comprising the steps of, presenting an image composed of several views of an object, compensating for any existing rotation of a preferred direction of the pixels, relative to a quasi-parallel preferred direction of a matrix on the structured optical plate, to the greatest possible degree by rotating the image presented by the pixels.

26. A method as set forth in claim 25, further comprising the steps of: compensating for any existing rotation by aligning a sequence of nearest-neighbor positions of bits of image information of one view in parallel to a sequence of non-opaque nearest-neighbor filter elements on a wavelength or neutral-density step filter array.

27. A method as set forth in claim 22 further comprising the step of, when an image composed of several views of an object is presented on the flat-panel display, combining the several views in such a way that bits of image information from two different views are simultaneously correlated to at least one smallest physical pixel.

28. The arrangement as set forth in claim 1, in which the plurality of optical elements comprises filter elements.

29. The arrangement as set forth in claim 8, in which the adhesive is a liquid.

30. The arrangement as set forth in claim 8, in which the adhesive is cedarwood oil.

31. A method as set forth in claim 27, in which the smallest physical pixel comprises a color subpixel
